(19) United States
(12) Patent Application Publication
(10) Pub. No.: US 2015/0058467 A1
(43) Pub. Date: Feb. 26, 2015

(54) FAST PROVISIONING OF PLATFORM-AS-A-SERVICE SYSTEM AND METHOD

(71) Applicant: Digital River, Inc., Minnetonka, MN (US)

(72) Inventors: Ryan Patrick DOUGLAS, Edina, MN (US); Michael Edwin OLSEN BORCHERT, Minneapolis, MN (US); Dana Elli JOHNSON, Minneapolis, MN (US); Kyle John FRIESEN, Shakopee, MN (US)

(21) Appl. No.: 14/528,796

(22) Filed: Oct. 30, 2014

Related U.S. Application Data
(63) Continuation-in-part of application No. 13/919,695, filed on Jun. 17, 2013.
(60) Provisional application No. 61/897,684, filed on Oct. 30, 2013.
(60) Provisional application No. 61/660,141, filed on Jun. 15, 2012.

(51) Int. Cl. H04L 12/24; G06Q 10/06

(52) U.S. Cl. CPC H04L 41/08; G06Q 10/0631
USPC 709/223

(57) ABSTRACT

A system and method for the fast, on-demand provisioning of platform-as-a-service is described. A customer submits a request for a platform, such as an e-commerce platform, by providing specifications for the infrastructure and identifying the type of platform required. The system automatically creates and tunes an infrastructure template. Applications and configuration details as well as other artifacts are installed on the template to create a platform model. The platform model is replicated to location and capacity specifications. Data Center and network details are registered so the platform may be identified on the network. The requestor may use the capacity for any period of time and then return it to the provider.

### RELATED APPLICATIONS

The present application is related to U.S. Patent Application No. 61/897,684, filed on 30 Oct. 2013, the entire contents of which are incorporated herein in its entirety. A claim of priority is made.

The present application is also a continuation-in-part of U.S. patent application Ser. No. 13/919,695, filed on 17 Jun. 2013, which claims priority to U.S. Patent Application No. 61/660,141 filed on 15 Jun. 2012, the entire contents of which are incorporated herein in its entirety. A claim of priority is made.

### FIELD OF THE INVENTION

The present disclosure relates to distributed computing, services-oriented architecture, and application service provisioning. More particularly, the present disclosure relates to platform-as-a-service provisioning of computer systems for electronic business.

### BACKGROUND OF THE INVENTION

Cloud computing is one of the fastest growing trends in computer technology. Often advertised as “The Cloud,” cloud computing means slightly different things to different people depending on the context. Nevertheless, most definitions suggest that cloud computing is a compelling way to deliver computer services to business organizations, allowing for rapid scale and predictable cost modeling in the deployment and management of applications.

By one definition, cloud computing is a methodology for delivering computational resources to consumers as a single service, rather than as discrete components. Computational resources, such as physical hardware, data storage, network, and software are bundled together in predictable, measurable units and delivered to consumers as complete offerings. Often, these offerings are delivered with tools to help consumers deploy and manage their applications with ease. Applications that best take advantage of cloud computing environments can scale quickly and utilize computing resources easily everywhere the cloud computing environment exists.

Private cloud computing offers significant benefits over traditional configurations of computing resources. Labor costs are reduced by up to 50 percent for configuration, operations, management and monitoring tasks; provisioning cycle times are reduced

Public cloud computing environments offered by companies to businesses and individuals offer a complementary cloud computing model. Amazon Web Services, Microsoft Azure, and Savvis Symphony are examples of such public cloud computing environments. Users typically consume computing resources and pay for those resources based on a uniform rate plus fees for usage. This utility model, similar to how a power company charges for electricity, is attractive to businesses seeking to operationalize certain IT costs. A savvy IT department may wish to utilize both private and public cloud computing environments to best meet the needs of business.

It traditionally takes weeks to procure and provision computing resources. Project managers and others determine their hardware and software requirements, create requisitions to purchase resources, and work with IT organizations to install and implement solutions. Organizations that implement a distributed computing model with a service provisioning solution can streamline this process, control costs, reduce complexity, and reduce time to solution delivery.

Currently, there are three prevailing types of cloud computing service delivery models: infrastructure-as-a-service, platform-as-a-service, and software-as-a-service. Infrastructure-as-a-service is a service delivery model that enables organizations to leverage a uniform, distributed computer environment, including server, network, and storage hardware, in an automated manner. The primary components of infrastructure-as-a-service include the following: distributed computing implementation, utility computing service and billing model, automation of administrative tasks, dynamic scaling, desktop virtualization, policy-based services and network connectivity. This model is used frequently by outsourced hardware service providers. The service provider owns the equipment and is responsible for housing, running, and maintaining the environment. Clients of these service providers pay for resources on a per-use basis. This same model may be leveraged by private organizations that wish to implement the same model for internal business units. Infrastructure-as-a-service is a foundation on which one may implement a more complex platform-as-a-service model, in which the deployment business systems may be modeled and automated on top of infrastructure resources.

An organization may use the cloud computing model to make resources available to its internal clients or external clients. Regardless of how an organization may use the infrastructure, it would be beneficial to have a system and method of deploying resources quickly and efficiently; one where design and delivery are based on performance and security criteria best suited for enterprise needs. One where the developer may merely ask for and receive a web server from IT, with time to delivery, cost of the implementation and the quality of end product predictable and repeatable with costs often lower than a traditionally supplied product.

Fast provisioning for an entire application platform is the next step from fast provisioning a cloud computing infrastructure; that is, it deploys one or more applications inside the virtual container created by a fast provisioning service for cloud computing. Further, it enhances a software-as-a-service (SaaS) offering by making the entire stack available to a client as a service. Platform-as-a-service may allow the client to build, enhance and tune the platform and the infrastructure as resources are required. For example, a client, who may be a web merchant, having a sale the following week may need additional capacity for online shopping, for a short period of time. A fast provisioning platform-as-a-service (PaaS) system and method allows the client to create this additional capacity essentially on demand, and then give it back to the provider when the high demand period is over. The features of the claimed system and method provide a solution to these needs and other problems, and offer additional significant advantages over the prior art.

### BRIEF SUMMARY

The presently disclosed system and method are related to a computerized system that implements platform-as-a-service. In order to most efficiently deploy cloud services to a company's private users, a fast provisioning system and method allows authorized users to create the environment they require in a minimum amount of time.

In a preferred embodiment of a Fast Provisioning of Platform-as-a-Service System and Method, a number of automation tools and components are combined to automate the process of provisioning an entire unit of platform capacity for any required period of time. For example, a web merchant planning a sale the following week may request an entire e-commerce platform, including data, catalog, etc. When the merchant sale is over, it may return the unit of capacity to the provider.

In a preferred embodiment, a fast provisioning platform-as-a-service system comprises a system deployment module and an operations orchestration module configured to receive the platform specifications and guide the workflow to create the infrastructure and install the platform artifacts to create a working platform. Other modules are provided, and comprise a subsystem that prepares configuration data, applications and artifacts for automated installation by an automation platform. The automation platform uses the prepared data to create the platform from the basic, generic infrastructure.

Additional advantages and features of the invention will be set forth in part in the description which follows, and in part will become apparent to those skilled in the art upon examination of the following or may be learned by practice of the invention.

### BRIEF DESCRIPTION OF THE DRAWINGS

FIG. 1 illustrates the fast provisioning platform-as-a-service in context, including the resulting environment.

FIG. 2 illustrates the components and process involved in provisioning a platform-as-a-service.

FIG. 3 is a screen shot of an exemplary screen for creating a platform request.

FIG. 4 is a screen shot of an exemplary screen for creating a tier required for a platform request.

FIG. 5 is a screen shot of an exemplary screen for creating additional tiers required for a platform request.

FIG. 6 illustrates the process of creating the infrastructure template and platform model that eventually becomes the provisioned platform.

FIG. 7 illustrates infrastructure-as-a-service architecture arenas.

FIG. 8 illustrates an infrastructure-as-a-service computing platform.

FIG. 9 illustrates a cloud bank deployment model.

FIG. 10 is a conceptual diagram of exemplary cloudbank resources.

FIG. 11 is a schematic cloud comprised of cloud banks.

FIG. 12 is a system virtualization model.

FIG. 13 depicts an Infrastructure-as-a-service communication fabric.

FIG. 14 depicts the logical organization of cloudbank virtual appliances.

FIG. 15 illustrates the cloudbank management VLAN.

FIG. 16 illustrates the global DNS servers for infrastructure-as-a-service name resolution.

FIG. 17a is a sequence diagram illustrating DNS resolution of a global application.

FIG. 17b is a sequence diagram illustrating DNS resolution of a service call via ESB.

FIG. 18a illustrates a single appliance load balancing model for an appliance zone.

FIG. 18b illustrates a multiple appliance load balancing model for an appliance zone.

FIG. 19 illustrates an exemplary component architectural diagram for an embodiment of a fast provisioning system.

FIG. 20 illustrates a Dashboard showing datacenter status for all of the data centers for which a user has access.

FIG. 21 is a screen shot of a “My Resource Pools” screen.

FIG. 22 illustrates resource pool and the virtual machines assigned to the user.

FIG. 23 is a screen shot of a virtual machine information screen.

FIG. 24 is a view of the resources in node-tree form.

FIG. 25 is a screen shot of a “Deploy Virtual machine” window used to select the resource pool for the resource to be deployed.

FIG. 26 is a screen shot of a “My Virtual Machine” screen.

FIG. 27 is a screen shot of a window providing options for selecting environment and role of the new resource.

FIG. 28 is a screen shot of a window providing the user with available chef cook book selections.

FIG. 29 is a screen shot of a window providing the user with available chef role selections.

FIG. 30 a screen sot of recipes associated with an exemplary role.

FIG. 31 is a screen shot of software version options supported by the company's fast provisioning system.

FIG. 32 is a screen shot of tuning options offered to a user.

FIG. 33 is a screen shot of tuning parameters offered to a user.

FIG. 34 is a screen shot of resource selection parameter confirmation popup window.

FIG. 35 is a screen shot of the “My Virtual Machines” screen during deployment of a new resource.

FIG. 36 is a confirmation message provided when the resource has been successfully deployed.

### DETAILED DESCRIPTION

Listed below are a few of the commonly used terms for the preferred embodiment of the Platform-as-a-service system and method.

### COMMON TERMS AND ACRONYMS

appliance: The term “appliance” refers to virtual appliance that packages an application (application appliance) or a software service (service appliance).

application: An application is a software program that employs the capabilities of a computer directly to a task that a user wishes to perform.

application appliance: An application appliance is a virtual appliance that packages an application.

chef recipes: Chef is an automation program which executes instructions required for all installed components in a particular system. Recipes tell Chef what artifacts are required where and how to install them at a particular location.

DASDirect: Attached Storage (DAS) is secondary storage, typically comprised of rotational magnetic disk drives or solid-state disk, which is directly connected to a processor.

DHCP: The Dynamic Host Configuration Protocol (DHCP) as specified by IETF RFC 2131 (Droms, 1997) and IETF RFC 3315 (Drom, Bound, Volz, Lemon, Perkins, & Carney, 2003) automates network-parameter assignment to network devices.

DNS: The Domain Name System (DNS) as specified by numerous RFC standards starting with IETF RFC 1034 (Mockapetris, RFC 1034: Domain Names—Concepts and Facilities, 1987) and IETF RFC 1035 (Mockapetris, 1987) is a hierarchical naming system for computers, services, or any resource connected to the Internet or a private network.

HTTP: The Hypertext Transfer Protocol as specified by IETF RFC 2616 (Fielding, et al., 1999).

HTTPS: HTTP over TLS as specified by IETF RFC 2818 (Rescorla, 2000).

IaaS: Infrastructure as a Service (IaaS) is the delivery of computer infrastructure (typically a platform virtualization environment) as a service. Infrastructure as a Service may be implemented either privately or publicly.

IP: The Internet Protocol as specified by IETF RFC 791 (Postel, 1981) or IETF RFC 2460 (Deering & Hinden, 1998).

ISA: An instruction set architecture (ISA) is the part of the computer architecture related to programming, including the native data types, instructions, registers, addressing modes, memory architecture, interrupt and exception handling, and external I/O. An ISA includes a specification of the machine language implemented by a particular processor.

Module: a self-contained component.

Operational Orchestration Tool: The Operational Orchestration tool provides an interface for creating the workflow to automatically create a Platform-as-a-Service.

PaaS: Platform-as-a-Service refers to the creation and provisioning of an entire computing platform, including infrastructure, applications and ancillary services.

processor: The term “processor” refers to the Central Processing Unit (CPU) of a computer system. In most computer systems that would be considered for inclusion within a Infrastructure-as-a-service implementation, the processor is represented by a single integrated circuit (i.e. a “chip”).

service: A service is a mechanism to enable access to a set of capabilities, where the access is provided using a prescribed interface and is exercised consistent with constraints and policies as specified by the service description (OASIS, 2006). Frequently, the term is used in the sense of a software service that provides a set of capabilities to applications and other services.

service appliance: A service appliance is a virtual appliance that packages a software service.

SLA: Service Level Agreement is a negotiated agreement between a service provider and its customer recording a common understanding about services, priorities, responsibilities, guarantees, and warranties and used to control the use and receipt of computing resources.

SMPA: symmetric multiprocessing architecture (SMPA) is a multiprocessor computer architecture where two or more identical processors can connect to a single shared main memory. In the case of multi-core processors, the SMP architecture applies to the cores, treating them as separate processors.

Stage: a stage is a designated environment, such as development, test, quality assurance, or production, that comes with specific requirements for set up and operation.

stovepipe: a set of servers and databases that make up an environment. Stovepipes are created using IaaS and are comprised of a web cache, web server, application server, application cache and order taker database. Stovepipes are associated with an order taker database and an operational data store.

Tier: a tier is a row or level of a structure providing a certain type of function in a platform environment. A tier can be a server assigned a certain role, such as an application server or web server, cache server, or may be a database or other type of structure.

Virtual IP address (VIP): an address set for a platform created in a data center.

virtual appliance: A virtual appliance is a software application or service that is packaged in a virtual machine format allowing it to be run within a virtual machine container.

VLAN: A virtual local area network (VLAN) is a group of hosts with a common set of requirements that communicate as if they were attached to the same broadcast domain, regardless of their physical location. A VLAN has the same attributes as a physical LAN, but it allows end stations to be grouped together even if they are not located on the same network switch. VLANs are as specified by IEEE 802.1Q (IEEE, 2006).

Wide IP (WIP): A wide IP is a mapping of a fully-qualified domain name (FQDN) to a set of virtual servers that host the domains content, such as a web site, an e-commerce site, or a CDN.

A fast provisioning platform-as-a-service system and method utilizes a number of modules stored in server memory, containing instructions which when executed automatically create platforms to a client user's specification, without engaging developers or systems administrators. These modules may be provided by means of a combination of commercially available automation tools, or may be developed specifically for this purpose.

A Fast Provisioning System for Platform-as-a-Service provides a system and method to rapidly create an application environment for internal IT groups or external clients. Platform-as-a-Service may be built over an infrastructure-as-a-service system and method, or may be a free-standing application that creates platform services over an established infrastructure. A novel fast provisioning system and method for infrastructure-as-a-service (IaaS) has been disclosed in a patent application filed on Jun. 17, 2013, application Ser. No. 13/919,695 and titled Fast Provisioning Service for Cloud Computing, for which this application claims priority as a continuation-in-part.

While PaaS will be described throughout this document in terms of provisioning an e-commerce system, this description is provided by way of example only and not limitation. A Fast Provisioning PaaS system and method may be applied to any other type of software application function as well, such as an enterprise system, warehouse logistics, etc.

The fast provisioning of a PaaS system and methods described herein take the elements of the e-commerce platform and wrap them in automation so they can be delivered at the click of a button. The primary pieces of an overall fast provisioning system for PaaS are: (1) automation around the components; (2) automation around the deployment of the e-commerce application (code); (3) configuration management (unique to the application system) which includes a database and a series of scripts and processes. The system and method described herein allows the user to run a script that retrieves for the app server and web server exactly the application version that the client requires. A configuration management tool with database, scripts and processes sews together the entire system. The client receives a running stack or stovepipe; a unit of capacity for the application. A command and control interface allows the client to tune parameters for a particular pool of resources and to ensure that the latest version of each of the component applications, scripts or other artifacts are the most up to date versions.

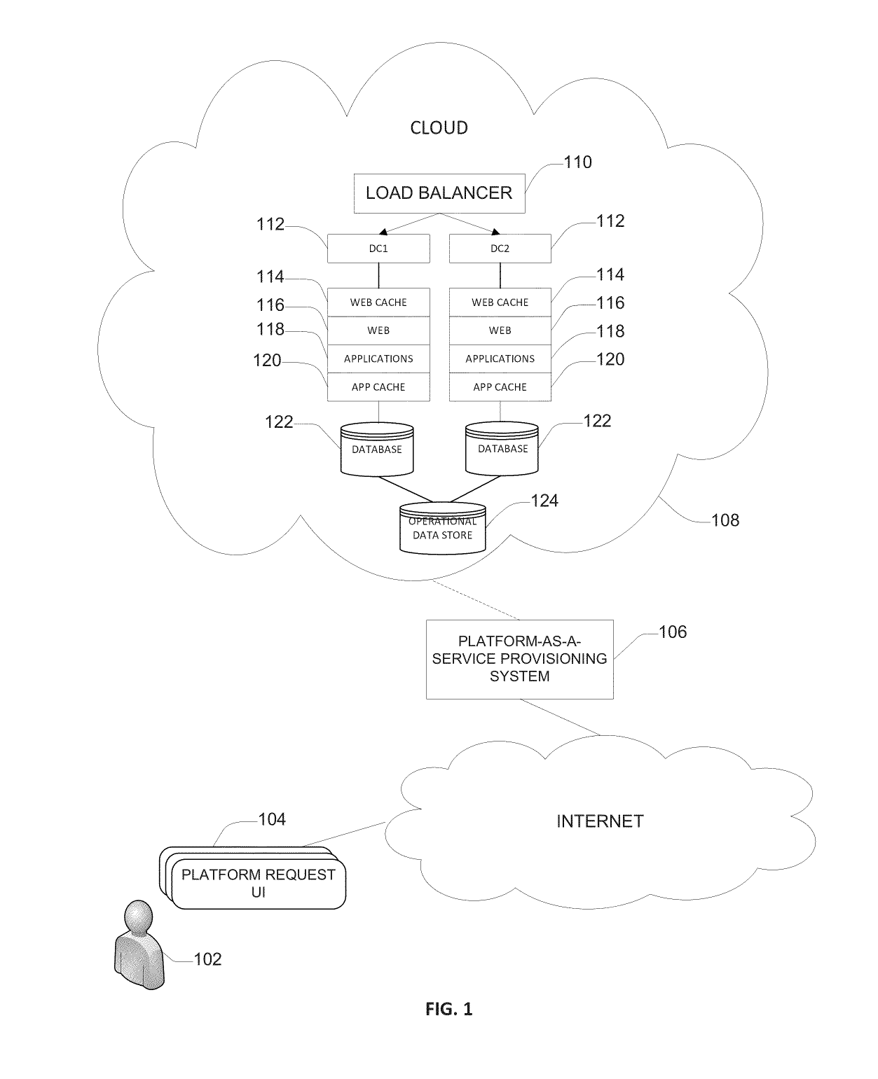

FIG. 1 illustrates the fast provisioning platform-as-a-service in context. A platform request web page 104 allows a customer 102 to request a fully functioning platform by providing a small number of specifications into a web-based interface 104. The request page feeds into the platform-as-a-service provisioning system 106 where the information is used to create a cloud-based platform 108 to the customer's specifications. The platform may be installed in a cloud computing environment and replicated to multiple data centers 110.

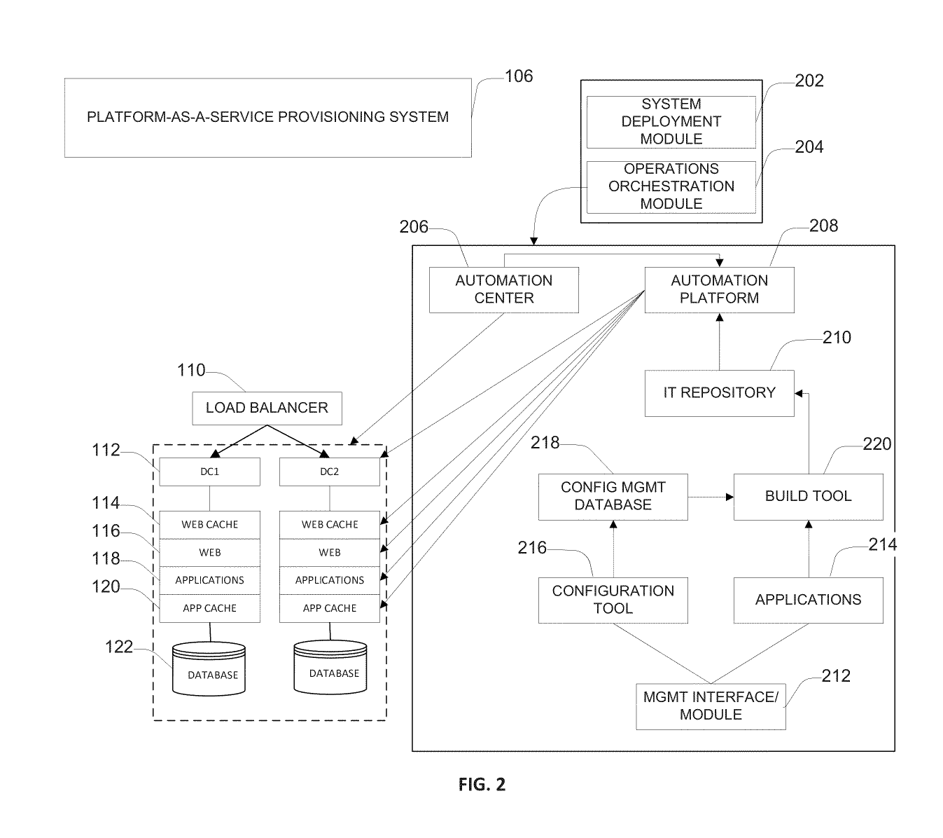

FIG. 2 is an exemplary illustration of a Platform-as-a-Service system 106 along with its component parts. Primary components are workflow tools; illustrated are a system deployment module 202, an operations orchestration module 204, an infrastructure automation tool 206, and an application or code automation platform 208. Supporting these primary components is an IT repository 210 comprising all of the necessary artifacts (e.g. code, scripts, applications, configuration details, etc.) required to set up the entire platform.

Referring again to FIG. 2, an applications 214 and configuration management 216 tool allows platform owners, systems administrators and others to manage these artifacts through a management interface and module 212. Configuration details are stored in a configuration management database 218. A build tool 220 creates files that are readable by the automation systems. These files are accessed by the automation systems 206, 208 ‘recipes’ which tell the automation system how to create the requested components, and what to put where and how to put it there. As will be described below, the provisioning system creates a stovepipe 110 as requested by the customer, and copies the stovepipe for a required number of data centers.

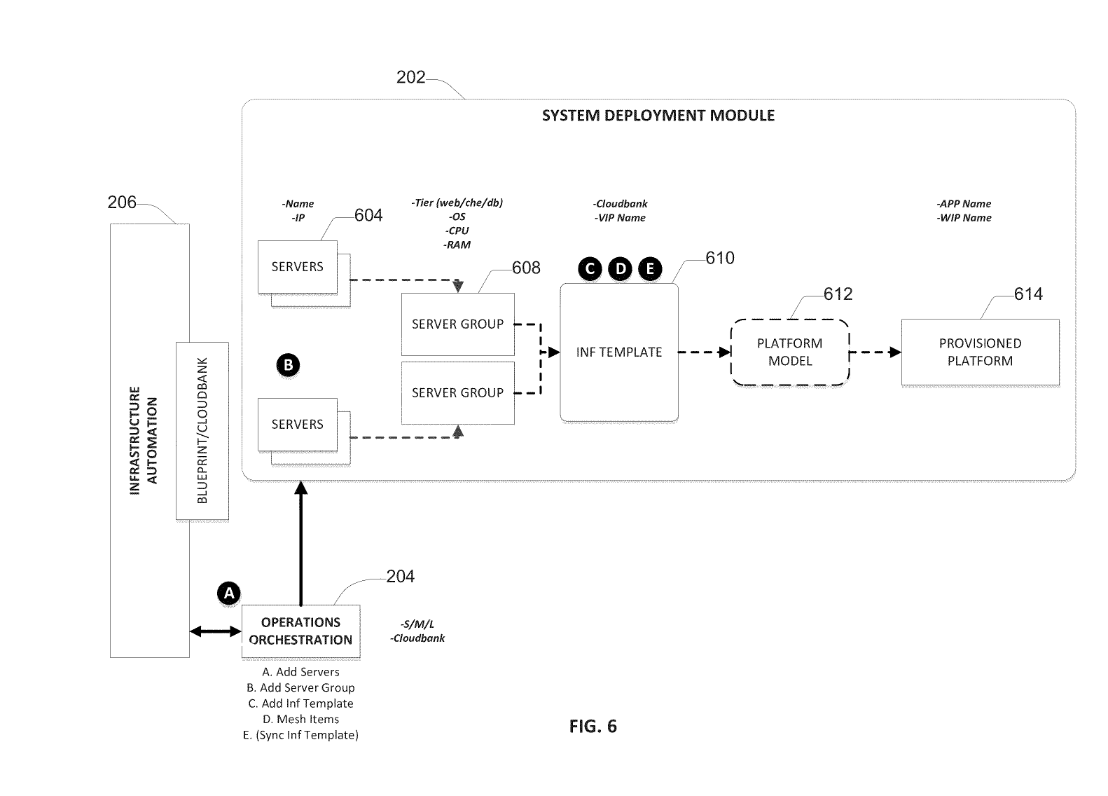

As will be discussed in more detail below (and in FIG. 6), the first step in the process is to stamp out an infrastructure template 610; a basic, generic machine with no customization. Cloudbank location and virtual IP name are assigned and registered. The system is rebooted in order to join the network and domain so that other tools can see the system to apply their software and configuration details. Software and general policy configurations are installed. The automation platform 208 runs to pull the code and the configuration sets and apply them to the newly built infrastructure. The final, provisioned platform 614 is named and assigned a WIP name, making it accessible to end users.

As was previously discussed, the primary pieces of a platform-as-a-service system 106 are: (1) automation around the components; (2) automation around the deployment of the e-commerce application (code); (3) configuration management (unique to the application system) which includes a database and a series of scripts and processes.

### Component Automation

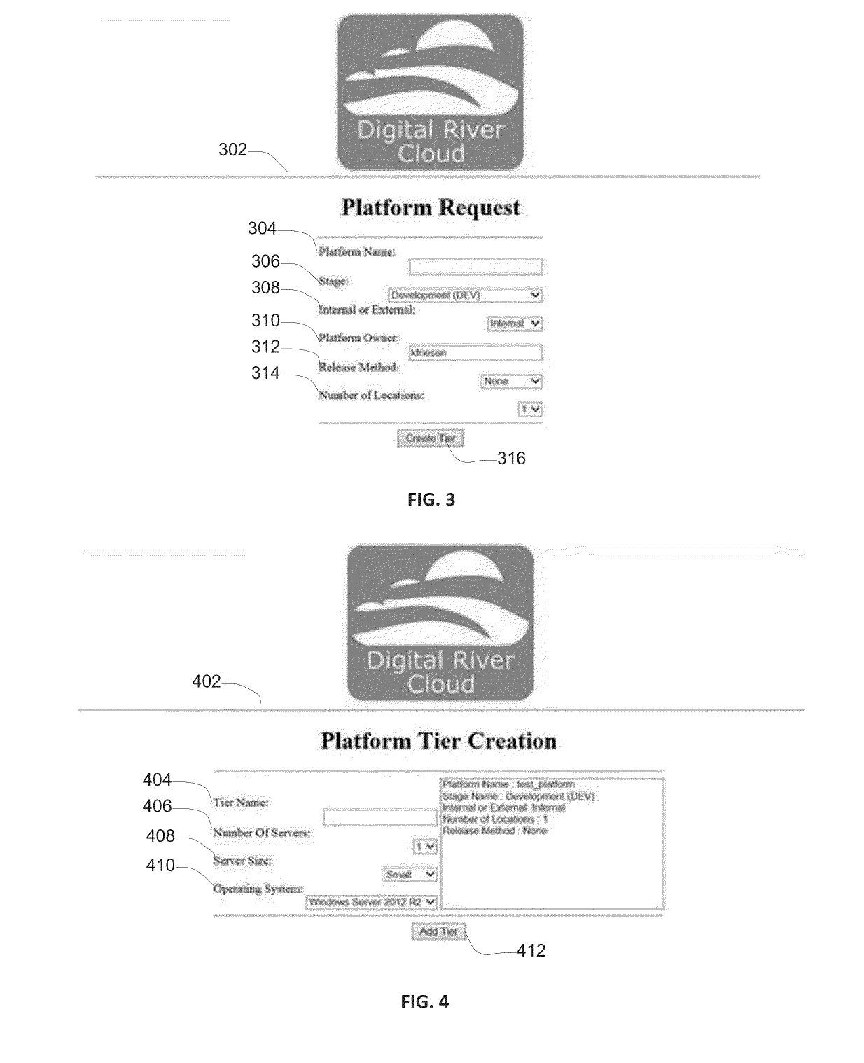

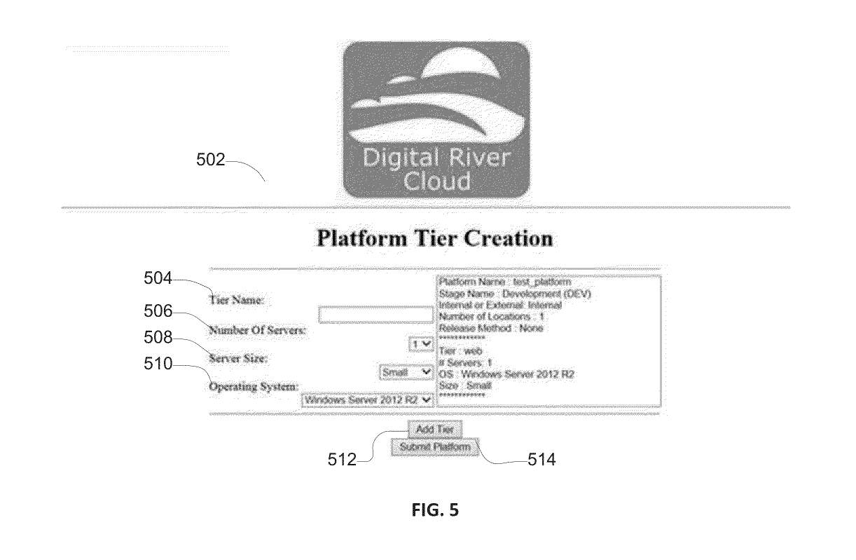

Referring now to FIGS. 3-5, the Platform Request web pages provide the interface for a customer to enter a platform request. After navigating to the web page, FIG. 3, 105, the customer 102 enters a name for the Platform 302, the stage requirement (e.g. development, quality assurance, test, production, etc.) 304, whether the platform is external or internal to the provider 306, the platform owner 308, the release method 310, and the number of locations 312 desired (for multi-tenant, multi-data center environments). On click, the customer 102 is presented with a Platform Tier Creation page, FIG. 4, 105. The customer selects Tier-related information, such as the Tier name (e.g. web, cache or database) 402, the number of servers required 404, the server size (small, medium or large) 406, and the operating system 408 required. Customers may create a number of tiers by “Add”-ing tiers on the Platform Tier Creation screen FIG. 5, prior to clicking the ‘Submit’ button 502 which submits the request to create the platform.

As FIG. 6 depicts, the platform specifications collected from the Platform Request page 104 are used to create a request with the System Deployment Module 202. Submitting the request triggers the operations orchestration module 204 to (1) make a call to the infrastructure automation component to create the virtual machines with the requested specifications, and (2) run transform operations that create configuration management database inputs, wraps them with parent/child associations and creates an infrastructure template request. The request is evaluated to determine which of a number of existing cloudbanks (servers, server groups) has the capacity to fulfill the request. Once this is determined, the operations orchestration 204 component kicks off a “new infrastructure template” flow for each location selected. The operations orchestration flow sends the infrastructure template information to the automation center 206 where virtual machines are created for each tier, servers are named and VIP addresses assigned 604. Server groups 608 are arranged into the requested tiers with the operating systems, processor and memory requirements requested by the customer and an infrastructure template 610 is created and named according to cloudbank and virtual IP name. An infrastructure template 610 may be copied in order to place identical stovepipes in multiple data centers.

### Application and Configuration Automation

A platform model 610 is created from the template 602. Platform models are named according to the customer's request 604. The System Deployment Module 602 causes the application automation module 208 to apply the correct software and configuration detail to the platform model according to design. A platform model 610 is replicated to enable the requested capacity, to the location specified. A URL is generated and assigned to the platform model. An email is sent to the requestor indicating creation of the platform model. Platform model identification details are registered in the data center locations and with the load balancer, completing the provisioned platform 614.

A platform model provides the infrastructure onto which the software applications and configuration details are installed to create a provisioned platform. Referring again to FIG. 2, the primary application deployment components are the System Deployment Module 202 and the Operations Orchestration Module 204, along with an automation center 206 and an automation platform 208. There are commercial products available that perform these services. For example, the HP Continuous Delivery Automation product, HP Operations Orchestration software, VSphere's Cloud Automation Center (VCAC) and Chef Automation software are commercially available products that may be used for 202, 204, 206 and 208, respectively.

A System Deployment Module 202 is a workflow tool which directs the process of provisioning the platform-as-a-service, by providing an interface to create, customize and easily deploy flows. Standard processes can be documented and structured documentation can be generated to support compliance requirements for process automation. The System Deployment Module 202 is configured to access the various components, scripts and processes to create the platform. In the context of this system, the System Deployment Module 202 accesses components 204, 206, 208 during the course of creating a platform-as-a-service.

### Components

The System Deployment Module 202 and Operations Orchestration Module 204 may be used as described above to deploy applications and automate processes, respectively. Referring back to FIG. 2, the Platform-as-a-service automation center 206 may be an enterprise tool used to build the stovepipe. A commercially available enterprise automation center 206 such as Vmware's Vsphere Cloud Automation Center (VCAC) may be used for this purpose. In one embodiment, taking the customer's request as input, the automation center creates the stovepipe (infrastructure-as-a-service) as described in that section below. Any number of tiers may be requested to perform the various functions required by the type of platform requested. In the case of an e-commerce platform, this might include web cache 114, web server 116, applications server 118, applications cache 120 and an order taker database 122. As is illustrated in FIG. 1, the database may be associated with an operational data store 124. These components may be sized and tuned automatically according to specifications.

In a preferred embodiment, the automation platform 208 uses instructional code to automate the delivery of PaaS components. A commercially available automation platform 208, such as Chef, uses instructions, called recipes, which tell the system what to put where, how to get it and how to put it in those places. A platform-as-a-service implementation for an e-commerce system, for example, would also be comprised of operating system software, policy configurations, applications, application configuration details and artifacts such as catalogs and data. For any infrastructure or platform requirement, an author creates a “recipe” that tells the automation platform 208 what is required where and how it should be put there, including dependencies.

An IT repository 210 may be a shared file system which holds the configurations, applications and artifacts that need to be accessed by the automation platform 208. The repository 210 is populated by a number of modules that take the artifacts and package them into a file that can be read and applied by the automation platform recipes. Applications 214 and configuration management 216 tools that provide the applications and configuration details required to deploy the e-commerce system software may be managed using a user interface module 212. A configuration tool 216 allows a user to change configuration details which are then stored in the configuration management database, CMDB, 218. A CMDB 218 is a collection of all items related to the commerce platform technologies. The CMDB 218 is comprised of all of the configuration details, requirements and dependencies for a particular state of the platform. The management module 212 also allows the user to manage all of the applications 214 that go make up the platform's code base.

In order for the details, data and applications comprising the platform to be used by the system they must be transformed into configuration files. The Platform-as-a-service provisioning system uses a Build Tool 220 to accomplish this. The Build Tool 220 checks the CMDB for the artifacts required to configure the application and creates a configuration package. The automation platform 208 contains instructions on how to take that configuration file from there and put the data on the local machine in the right places.

In a preferred embodiment, the Build Tool 220 builds the application's code base and individual application server configuration files. It retrieves configuration details and transforms them into a configuration file. In other words, it checks the CMDB 218 for the artifacts required to configure the application and creates a configuration package. The Build Tool 220 does the same for all of the applications required to run the platform. These application and configuration packages are transformed into files that are usable by Chef. Chef contains recipes for creating each tier of the platform. A user may run a build, which pulls data out of the CMDB 218, including how and what to build, packages it and puts it in the IT repository. A chef recipe may query the CMDB 218 for certain pieces of data, including instructions on what build it should deploy. It pulls the artifacts and configuration package from the repository. The build tool pulls down all the code and the configuration details which are then deployed on to the virtual machine, tier (114-122), which represents the application.

Creation of the platform—the servers 114-120 and databases 122—is fully automated in this way. A shared file system includes all of the data required for the platform. For an e-commerce platform that includes catalog, product configurations, images, custom templates, etc. All is provisioned for the customer for just the period of time it is required, and may be relinquished when the need no longer exists.

### Load Balancing

A load balancing system allows the platform to be recognized by the cloud computing environment. The load balancer 110 must be configured to recognize the newly created platform. In the cloud computing environment, anyone who uses the system enters it through the load balancer. The load balancer 110 is the conduit for directing traffic to each of the created stovepipes. The load balancer contains information related to all of the data center 112 components. An organization offering PaaS may identify its data center components using both wide IP (WIP), for directing traffic at a high level to the appropriate data center 112, and virtual IP (VIP) for directing traffic to the appropriate stovepipe within the data center 112. Registration of the location of a particular constructed platform allows the user to access the platform over the internet after creation via the load balancer.

Referring again to FIG. 1, a load balancer 110 interfaces with incoming traffic and the various data centers and stovepipes within the data centers 112. The load balancer 110 registers the environments in the data center 112 and connects incoming traffic (users) with the appropriate stovepipe. Internet and domain names are DNS load balanced across single DNS records or name on the internet, and are split out using the load balancing device 110. This is the DNS load balancing 110 across data centers 112 at a GTM (global traffic manager) level. It does the first level split among data centers. DC1 112 and DC2 112 represent a plurality of data centers 112 available in the environment. This is a Wide IP or WIP. Based on location, the incoming message is routed to a particular data center 112. If one data center is down, WIP stops giving out that IP address. Then there is a second level within the data center which is the load balancing local traffic manager (LTM). The LTM directs traffic to the replicated platforms using the virtual IP or VIP. Each of the boxes in the data center 112 has an IP address associated with it and a definition in the load balancing device 110. And this is backed by actual global commerce stovepipes in the data center 112 that consist of Web cache 114, web 116, applications 118 and application cache 120 and the balancing split is between the boxes in the data center.

### Infrastructure-as-a-Service for Cloud Computing

As was disclosed above, in one embodiment, platform-as-a-service may be the next step up from infrastructure-as-a-service. Once the infrastructure is created as described below, the flow for creating platform-as-a-service enters the infrastructure template 610 stage and is ready for the platform model 612 stage. The process leading up to the template stage is described below.

Although the disclosure primarily describes the claimed system and method in the terms and context of a private IaaS (private cloud), it is equally applicable to a public cloud made available to external clients, or a configuration and client base that is a combination of the two.

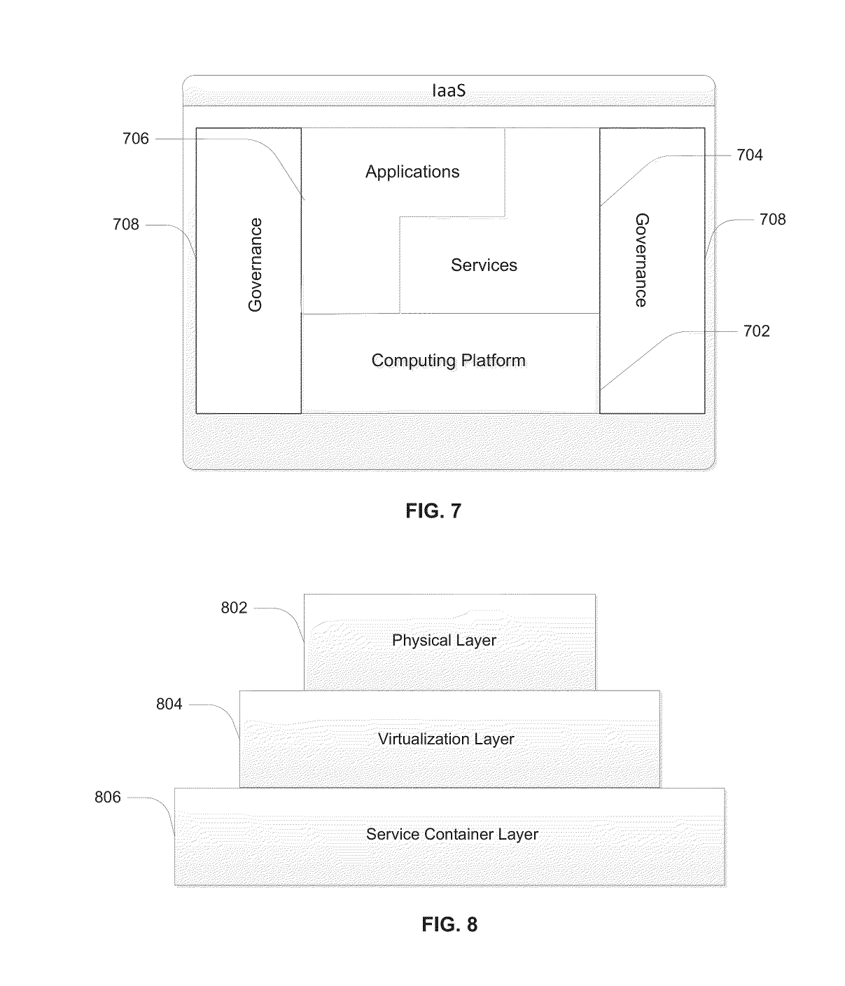

Exemplary Infrastructure-as-a-Service (IaaS) architectural contexts are illustrated in FIG. 7. The system may be comprised of an “elastic” computing platform 702, a portfolio of software services 704 and applications 706, and a governance process 708 to oversee and control the computing platform and the services portfolio. The IaaS platform provides the computational, communication, storage and management infrastructure within which services and applications run. It provides a private “compute cloud” providing IaaS.

Some characteristics of such an exemplary computing platform include: the use of primarily commodity hardware packaged in small units that permit easy horizontal scaling of the infrastructure; the use of virtualization technology to abstract away much of the specifics of hardware topology and provide elastic provisioning; SLA monitoring and enforcement; and resource usage metering supporting chargeback to platform users.

In one exemplary embodiment, computing platform architecture is comprised of a Physical Layer 802, a Virtualization Layer 804, and a Service Container Layer 806, as is illustrated conceptually in FIG. 8. The Physical Layer 802 consists of the hardware resources; the Virtualization Layer 804 consists of software for virtualizing the hardware resources and managing the virtualized resources; and the Service Container Layer 806 consists of a standard configuration of “system services” that provide a container in which application appliances and service appliances run. The computing platform focuses on providing a horizontally scalable infrastructure that is highly available in aggregate but not necessarily highly available at a “component level”.

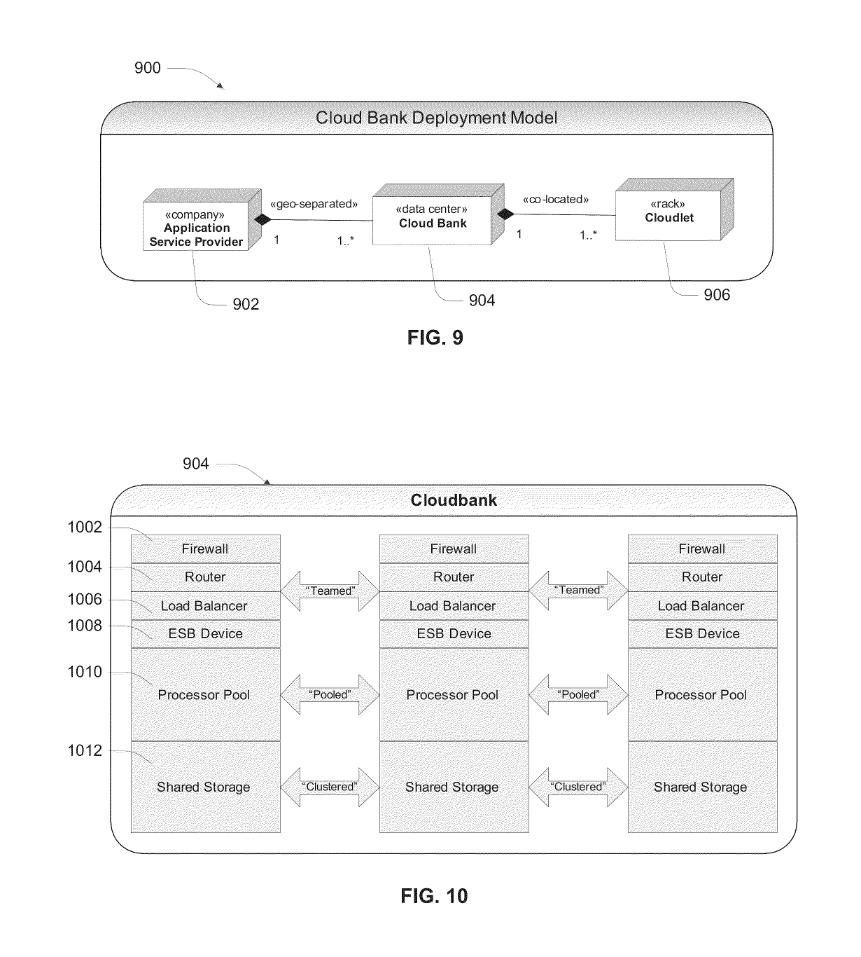

FIG. 9 illustrates a cloud bank deployment model 900. An ecommerce or other network-based service provider 902 maintains a data center with “cloud banks” 904, with a cloudlet 906 being the unit of capacity in the computing platform. A cloudlet 906 is comprised of a standardized configuration of hardware, virtualization and service container components. It is intended that cloudlets 906 can “stand alone” either in a provider's data center or in a co-location facility. Cloudlets 906 are general purpose, not being tuned to the needs of any particular application or service, and are not intended to be highly reliable. Therefore, applications and services whose availability requirements exceed the availability of a cloudlet 906 must “stripe” the application across a sufficient number of cloudlets 906 to meet their needs. Within a cloudlet 906, appliances have low latency, high throughput communication paths to other appliances and storage resources within the cloudlet.

A collection of cloudlets 906 in the same geographical location that collectively provide an “availability zone” is called a cloudbank 904. A cloudbank 904 is sized to offer sufficient availability to a desired quantity of capacity, given a cloudlet 906 lack of high availability. A single data center can and often should contain multiple cloudbanks 904. The cloudbanks 904 within a data center should not share common resources, like power and internet (extra-cloudbank) connectivity, so that they can be taken offline independently of one another.

Cloudlets 906 represent units of “standard capacity” containing storage, processing and networking hardware, coupled with virtualization layer. When aggregating cloudlets 906 into cloudbanks 904, the network resources (firewalls, routers, load balancers, and enterprise service bus (ESB) devices) are typically “teamed,” storage elements clustered and processor elements “pooled” to increase the capacity of the resources being virtualized.

FIG. 10 is a conceptual diagram of exemplary cloudbank 904 resources. Components include firewall 1002, router 1004, load balancer 1006, ESB device 1008, processor pools 1010 and shared storage clusters 1012. Routers 1004 and load balancers 1006 are teamed across all cloudlets 706 in the cloudbank 704. The processor 1010 elements are “pooled” to increase the capacity of the resources being virtualized.

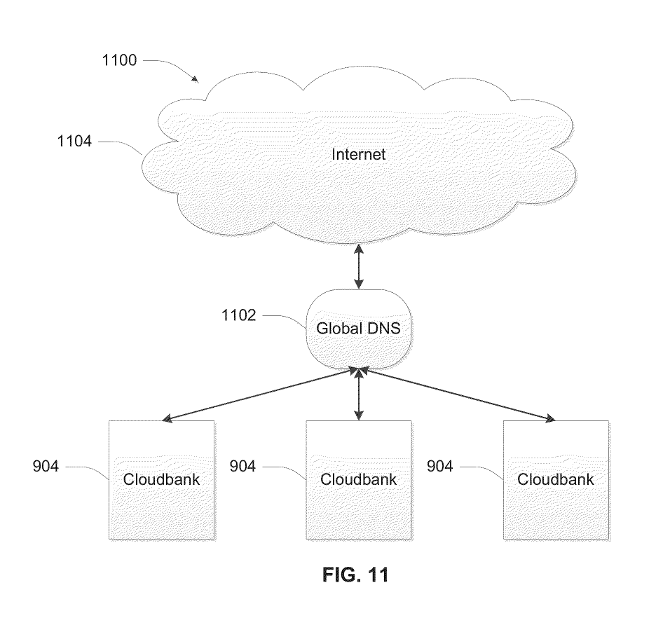

FIG. 11 is a schematic cloud 1100 comprised of cloudbanks 904. External to the cloudbanks is some form of “intelligent DNS” 1102; in other words, a DNS server that utilizes some form of network topology-aware load-balancing to minimize the network distance between a client and a cloudbank resident resource. In addition, it utilizes some awareness of the availability of a cloudbank resource to avoid giving a client the address of a “dead” resource. This can be referred to as a private cloud “global DNS” server. Communications are made over a network, such as the internet 1104.

As will be discussed further below, applications and services are packaged as appliances using one of the virtual machine formats supported by the computing platform. Appliances will package an operating system image and the virtualization layer should support a variety of operating systems, thereby allowing the appliance designer wide latitude to select the operating system most appropriate for the appliance.

Appliances that are well designed for the IaaS may use distributed computing techniques to provide high aggregate availability. Further, well-designed appliances may support cloning, thereby allowing the computing platform to dynamically provision new appliance instances. While the platform is providing a general-purpose computing platform that is not optimized for any specific service or application there are some workload characteristics that are prevalent. Specifically, workloads tend to favor integer performance over floating point performance and single thread performance over multi-threaded performance. Workloads tend to be memory intensive as opposed to CPU intensive. They are often I/O bound, primarily trying to access slow (external) network connections for slow mass storage (disk, often via a database system). Certain workloads (such as distributed file systems) will benefit greatly from having Direct Access Storage (DAS).

### Physical Layer

Referring again to FIG. 9, the basic component of the Physical Layer 802 of Infrastructure-as-a-service is the cloudlet 906. A cloudlet 906 is comprised of a collection of processing, storage, ESB and networking components or elements. Cloudlet 906 components are based upon, for the most part, general-purpose commodity parts.

Processing elements supply the computational capacity for the cloudlet 906. They are typically “blade” or “pizza box” SMP systems with some amount of local disk storage. Processing elements in Infrastructure-as-a-service utilize a “commodity” processor design whose ISA is widely supported by different software technology “stacks” and for which many vendors build and market systems. A processing element generally consists of one or more processors, memory and I/O subsystems.

Each cloudlet 906 has one storage element that provides a pool of shared disk storage. Storage elements utilize commodity disk drives to drive down the cost of mass storage. A storage element (singular) may be comprised of multiple physical storage devices. Processing elements are connected to one another and to storage elements by a high speed network element. A network element (singular) may be comprised of multiple physical network devices.

Cloudlets 906 are combined together into cloudbanks 904. Cloudbanks 904 provide both capacity scale out, as well as reliability improvement. Some resources, like power and internet connectivity are expected to be shared by all cloudlets 906 in a cloudbank 904, but not be shared by different cloudbanks 904. This means that high availability (four nines or more) is obtained by spreading workload across cloudbanks 904, not cloudlets 906.

### Virtualization Layer

The Virtualization Layer 804 of Infrastructure-as-a-service abstracts away the details of the Physical Layer 802 providing a container in which service and application appliances, represented as system virtual machines, are run. The Virtualization Layer 804 consists of three parts: system virtualization, storage virtualization, and network virtualization.

System virtualization is provided by a software layer that runs system virtual machines (sometimes called hardware virtual machines), which provide a complete system platform that supports the execution of a complete operating system, allowing the sharing of the underlying physical machine resources between different virtual machines, each running its own operating system. The software layer providing the virtualization is called a virtual machine monitor or hypervisor. A hypervisor can run on bare hardware (so called, Type 1 or native VM) or on top of an operating system (so called, Type 2 or hosted VM). There are many benefits to system virtualization. A few notable benefits include the ability for multiple OS environments to coexist on the same processing element, in strong isolation from each other; improved administrative control and scheduling of resources; “intelligent” placement of and improved “load balancing” of a workload within the infrastructure; improved ease of application provisioning and maintenance; and high availability and improved disaster recovery.

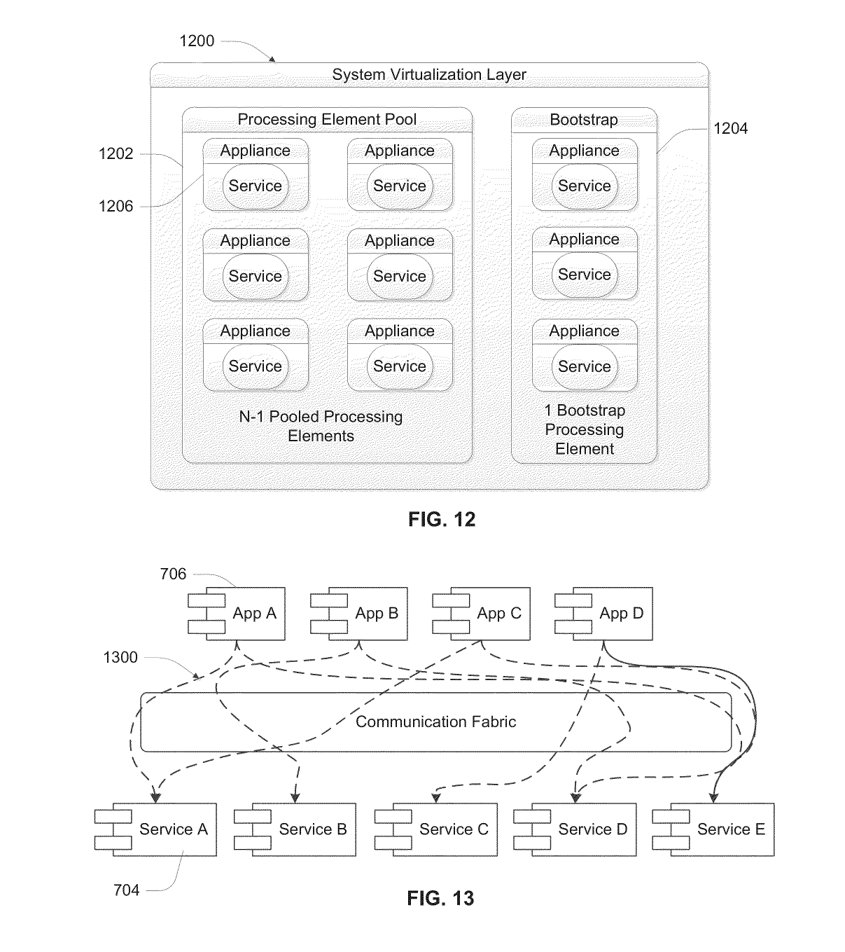

The virtualization layer 1200 illustrated in FIG. 12 treats the collection of processing elements comprising a cloudbank 904 as a pool of resources to be managed in a shared fashion. The system virtualization layer is illustrated with a processing element pool 1202 and a bootstrap processing element 1204.

In a preferred embodiment, services and applications are packaged as appliances 1206. An appliance 1206 is a virtual machine image that completely contains the software components that realize a service or application. The ideal appliance 1206 is one that can be cloned in a simple, regular and automated manner, allowing multiple instances of the appliance 1206 to be instantiated in order to elastically meet the demands of the workload.

Appliances 1206 will typically be associated with an environment that has common access control and scheduling policies. Typical environments are “production”, “staging”, “system test”, and “development”. Development personnel may have “free reign” to access resources in the development environment, while only select production support personnel may have access to resources in the production environment. When multiple environments are hosted on the same hardware, the production environment has the highest scheduling priority to access the resources, while the development environment might have the lowest scheduling priority to accessing resources. In IaaS, the system virtualization layer 804 can support multiple environments within the same resource pool.

The system virtualization layer 804 typically provides features that improve availability and maintainability of the underlying hardware, such as the capability to move a running virtual machine from one physical host to another within a cluster of physical hosts to, for example, facilitate maintenance of a physical host; the capability to move a running virtual machine from one storage device to another to, for example, facilitate maintenance of a storage device; automatic load balancing of an aggregate workload across a cluster of physical hosts; and the capability to automatically restart a virtual machine on another physical host in a cluster in the event of a hardware failure.

Storage virtualization is provided by either system virtualization software or by software resident on the network attached shared storage element. In the first case, many virtualization layers expose the notion of a “virtual disk”, frequently in the form of a file (or set of files) which appear to a guest operating system as a direct attached storage device. The second case is seen, for example, when a logical device is exposed as by Network File System (NFS) or Common Internet File System (CIFS) server.

Network virtualization is provided by either system virtualization software or by software resident on the attached network element. In the first case, many virtualization systems utilize the notion of a “virtual network device”, frequently in the form of a virtual NIC (Network Interface Card) or virtual switching system which appear to a guest operating system as a direct attached network device. The second case is seen, for example, when a logical device is exposed as a virtual partition of a physical Network Element via software configuration.

### Service Container Layer

FIG. 13 illustrates the IaaS communication fabric 1300. A cloudbank 904 hosts a suite of virtual appliances 1206 that implement an ecosystem of applications 706 and services 704. For the purposes of this specification, an application 706 is a software component that is accessed “directly” from “outside” of the cloud, often by a user. A typical example of an application 706 is a web site that is accessed “directly” from a browser. In contrast, a service 704 is a software component that is typically invoked by applications 706, themselves often resident within the IaaS cloud. Services 704 are not accessible directly, but only by accessing the IaaS communication fabric 1300. The communication fabric 1300 provides a common place for expressing policies and monitoring and managing services. The term “communication fabric” may be synonymous with “ESB” and in this document we use the terms interchangeably.

When an application, whether external or internal to the IaaS cloud, invokes a service 704 it does so by sending the request to the communication fabric which proxies the request to a backend service as in FIG. 13. Applications 706 are public and services 704 are private. Both services 704 and applications 706 are realized by a collection of virtual appliances 1206 behind an appliance load balancer. This collection of virtual appliances 1206 and load balancer (which may be software load balancer realized by another virtual appliance 1206) is called an appliance zone (or simply zone in contexts where there is no ambiguity) and it should be associated, one to one, with a virtual LAN. Note that the appliance zone must be able to span all the cloudlets 906 in a cloudbank 904; hence, a VLAN is a cloudbank-wide 904 resource. At the “front” of the cloudbank 904 is the cloudbank load balancer that is responsible for directing traffic to application zones or the ESB, as appropriate.

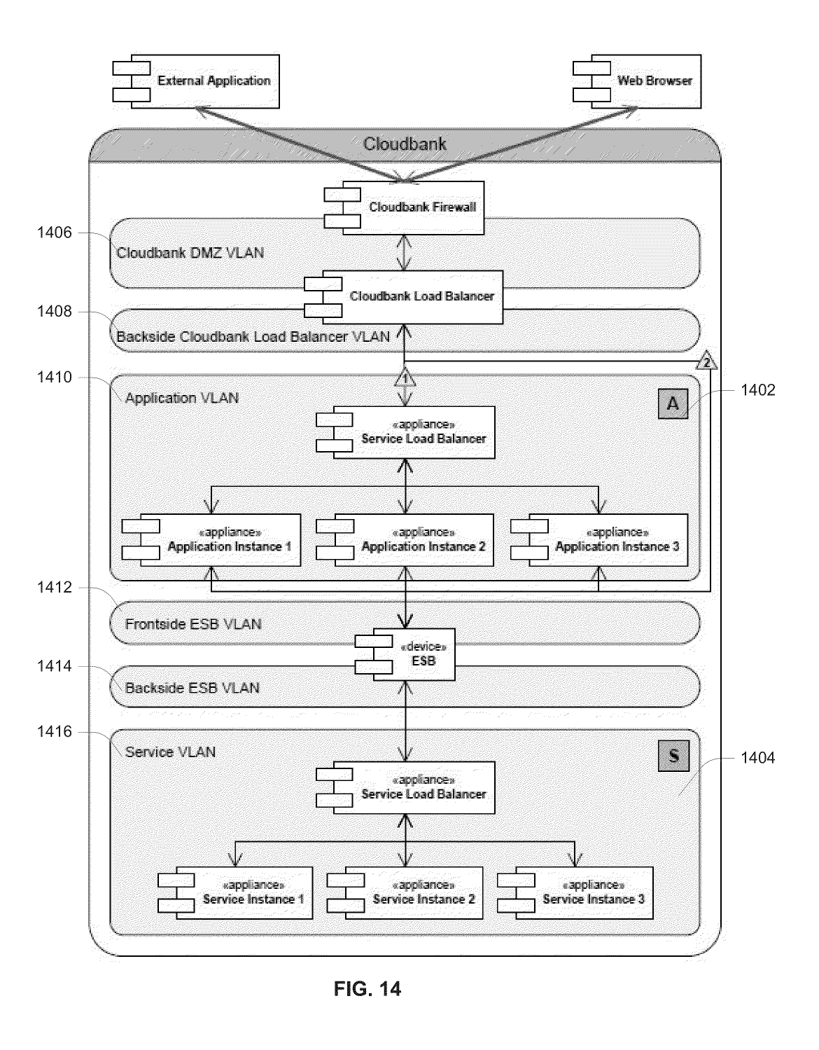

FIG. 14 depicts the logical organization of the cloudbanks 904 virtual appliances and load balancing components to handle traffic for applications 706 (labeled by route 1 on the figure) and services 704 (labeled by route 2 on the figure). The box labeled A 1402 represents an application zone, while the box labeled S 1404 represents a service zone. Also shown are examples of management VLANS that are also found in the infrastructure, including cloudbank DMZ VLAN 1406, backside cloudbank load balancer VLAN 1408, Application VLAN 1410, frontside ESB VLAN 1412, backside VLAN 1416 and service VLAN 1416.

Thus far, it has been a challenge to get such a system up and running. What is required is an automated system and method for provisioning such cloud components on demand. The automated and elastic provisioning provided in this disclosure provides a solution to this problem and offers other advantages over the prior art.

### Automated and Elastic Provisioning

An important feature of a preferred embodiment of an infrastructure-as-a-service system and method is the support for automated and elastic provisioning, which enables significantly improved IT efficiencies in managing the infrastructure. Also known as “fast provisioning,” automated and elastic provisioning greatly improves the time required to set up and productionize computing infrastructure. Automated provisioning is the use of software processes to automate the creation and configuration of zones and “insertion” and “removal” of a container into the cloud. Elastic provisioning is the use of software processes to automate the addition or removal of virtual appliances within a zone in response to the demands being placed upon the system.

Some of the resources that an automated provisioning system and method manage include:
1. a catalog of virtual appliances,
2. an inventory of network identifiers: MAC addresses, IP addresses and hostnames
3. network router and ESB device configurations

The naming and identification conventions that are adopted are preferably “friendly” to automation. Within the appliance zone, each virtual appliance may be allocated a unique IP address. The IP address allocated to a virtual machine must remain the same, regardless of where the virtualization layer places the virtual appliance within the cloudbank. The zone exposes the IP address of the appliance load balancer as the external IP address of the zone's application or service to its clients. For service zones, the “client” is always the ESB. Although not required by IEEE's 802.1Q standard (IEEE, 2006), it is expected that each VLAN is mapped to a unique IP subnet. Therefore, like VLANs, IP subnets are cloudbank-wide resources. IP addresses for a cloud-bank are managed by a cloudbank-wide DHCP server to which DHCP multicast traffic is routed by a DHCP proxy in the cloudbank router. The DHCP service is responsible for managing the allocation of IP addresses within the cloudbank.

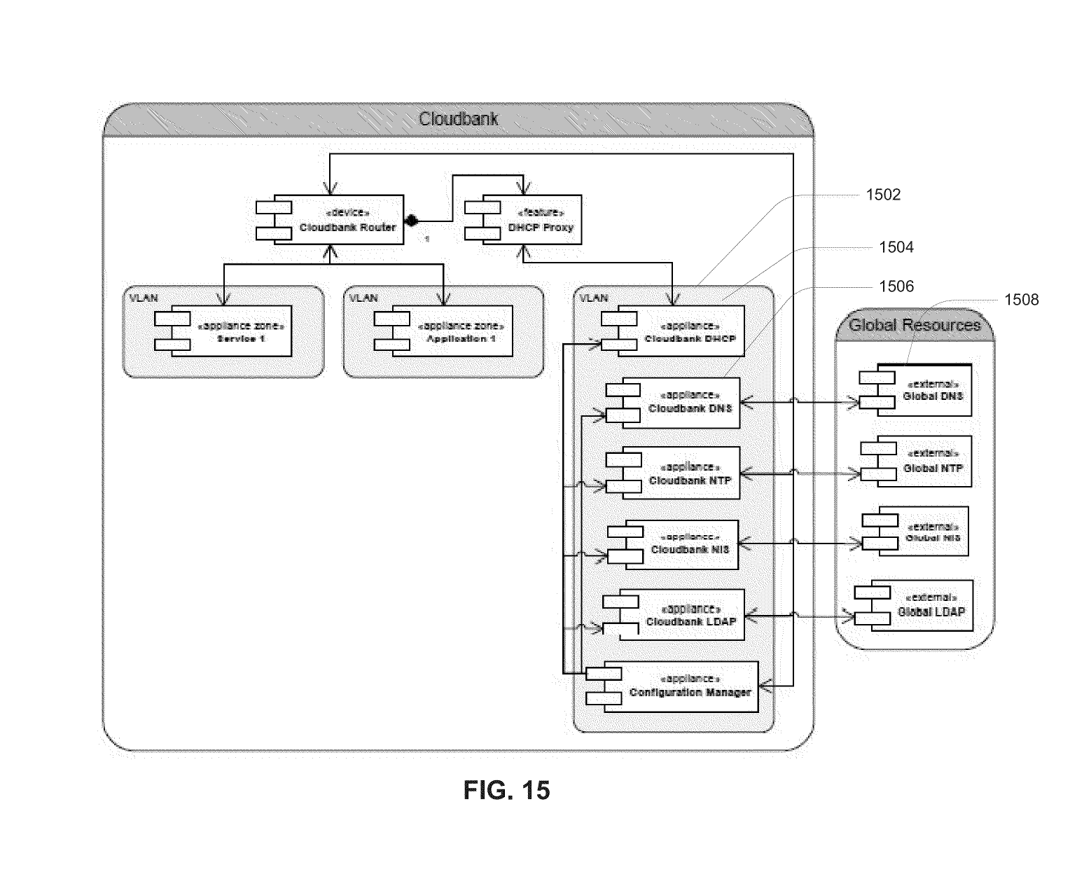

Referring to FIG. 15, the VLAN at the right of the figure is called the cloudbank management VLAN 1502 and it contains a number of appliances that provide capabilities for the Service Container Layer 806. The Cloudbank DHCP appliance 1504 implementing the DHCP service is shown in the figure.

Sometimes it is necessary for an appliance running in one cloudbank 904 to be able to communicate directly to its peer appliances running in other cloudbanks (appliances implementing DHTs or internal message buses need to do this). Therefore, the IP allocation scheme probably cannot impose the same set of private IP addresses to each cloudbank 904, but instead must allow some form of “template” to be applied to each cloudbank 904. Each cloudbank would apply a common allocation “pattern” that results in unique addresses (within the environment infrastructure) for each cloudbank 904.

### Host and Domain Name Management

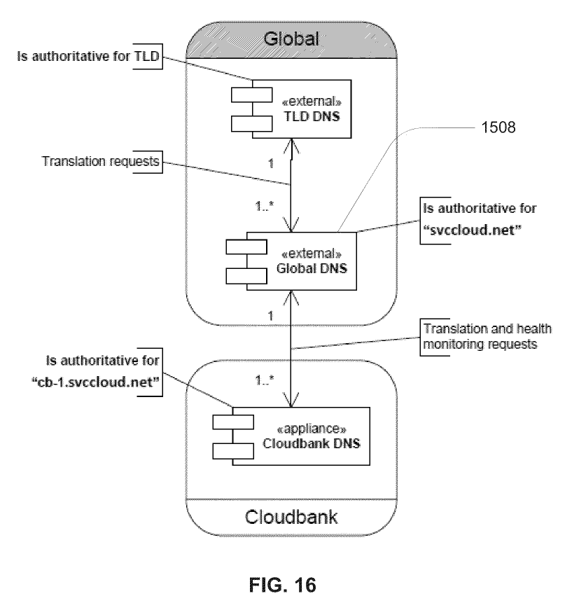

FIG. 15 also shows a cloudbank DNS appliance 1506 in the management VLAN. It performs all name resolutions within the cloudbank 904. It is the authoritative DNS server for the cloudbank's 904 domain. A Global DNS 1508, also illustrated in FIG. 16, exists outside the IaaS cloud. It is the authoritative DNS server for the global IaaS domain namespace (“svccloud.net”). The Global DNS server 1508 should be capable of performing “location aware” ranking of translation responses, ordering the response list according to the network distance or geographical proximity of the resource (a cloudbank 904) to the client, with those resources residing closer to the client being returned before resources that are farther from the client. The Global DNS 1508 should also be able to filter its response based upon the availability of the resource as determined by a periodic health check of the cloudbank 904 resources.

Cloudbank DNS servers 1506 must have secondary instances for high availability. Furthermore since the primary cloudbank DNS 1506 runs inside a virtualization container that refers to names that the cloudbank DNS 1506 is responsible for translating, failures may not be correctable (“chicken and egg” problems) without a reliable secondary. Therefore, a cloudbank DNS 1506 server must have secondary instances and at least two secondary instances must reside outside the cloudbank 904. A recommended configuration is to run one secondary in another cloudbank 904 and a second in a highly available DNS host altogether external to the cloud.

Uniform naming of resources is important to ease automated and elastic provisioning. FIG. 16 illustrates an exemplary configuration of DNS servers for DNS name resolution. An exemplary naming convention is described in Table 1, below.

TABLE 1
A DNS Naming convention

| DNS Name | Description |
|---|---|
| svccloud.net | Domain name of the cloud as a whole. The global |
| | DNS server is responsible for performing name |
| | resolution for this domain. |
| cb-1.svccloud.net | Domain name of cloudbank one. The cloudbank |
| | DNS is responsible for performing name resolution |
| | for this domain. Each cloudbank is assigned a |
| | decimal identifier that uniquely identifies it within |
| | the cloud. |
| z-1.cb- | Domain name of the appliance zone within one |
| 1.svccloud.net | cloudbank one. The cloudbank DNS is responsible |
| | for performing name resolution for this domain. |
| | Each zone is assigned a decimal identifier that |
| | uniquely identifies it within the cloudbank in which |
| | it resides. |
| a-1.z-1.cb- | Host name of appliance one within appliance zone |
| 1.svccloud.net | one of cloudbank one. The cloudbank DNS is |
| | responsible for resolving this name. |
| | Each appliance is assigned a decimal identifier that |
| | uniquely identifies it within the appliance zone in |
| | which it resides. |
| {resource}.- | Global name of a resource within the cloud. These |
| svccloud.net | names are resolved by the global DNS to a list of |
| | cloudlet specific resource names (A records). In a |
| | preferred embodiment, the global DNS can order |
| | the returned names by network distance or |
| | geographical proximity of the client to a cloudbank. |
| | Additionally, it is desirable for the Global DNS |
| | server to be able to “health check” the cloudbank |
| | names to avoid sending a client an unavailable |
| | endpoint. |
| esb.svccloud.net | Global host name of an ESB resource within the |
| | cloud. This name is resolved by the global DNS to |
| | a list of cloudbank specific ESB resource addresses |
| app- | Global host name of an application called “app- |
| foo.svccloud.net | foo” within the cloud. This name is resolved by the |
| | global DNS to a list of cloudlet specific “app-foo” |
| | resource addresses |
| service- | Global host name of a service called “service-bar” |
| bar.svccloud.net | within the cloud. This name is resolved by the |
| | global DNS to a list of cloudlet specific “service- |
| | bar” resource addresses. |
| {resource}.cb- | Host name of a resource within cloudbank one. |
| 1.svccloud.net | These names are resolved by the cloudbank DNS to |
| | a list of addresses of the resource (usually the load |
| | balancers fronting the resource). |
| esb.cb- | Host name of an ESB resource within cloudbank |
| 1.svccloud.net | one. This name is resolved by the cloudbank DNS |
| | to a list of cloudbank specific addresses for the |
| | load-balancers fronting the ESB devices. |
| app-foo.cb- | Host name of an application called “app-foo” |
| 1.svccloud.net | within cloudbank one. This name is resolved by |
| | the cloudbank DNS to a list of cloudbank specific |
| | addresses for the load-balancers fronting the |
| | application appliances. |
| service-bar.cb- | Host name of a service within cloudbank one. This |
| 1.svccloud.net | name is resolved by the cloudbank DNS to a list of |
| | cloudbank specific addresses for the load-balancers |
| | fronting the ESB devices. |

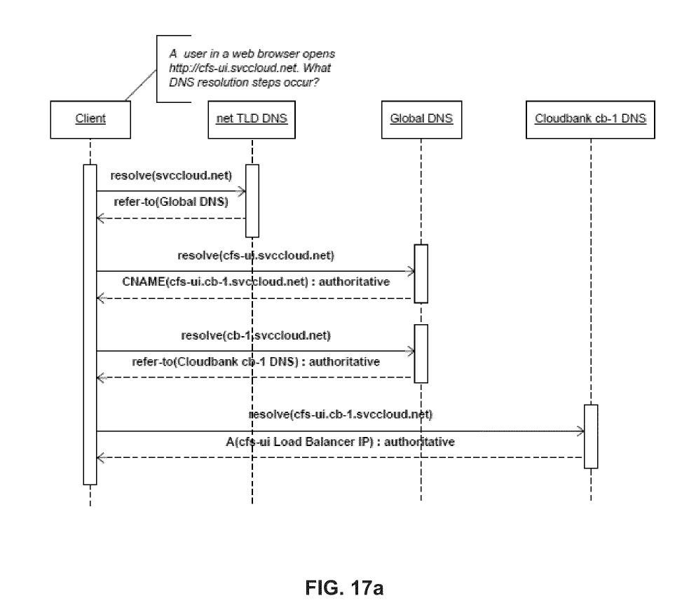

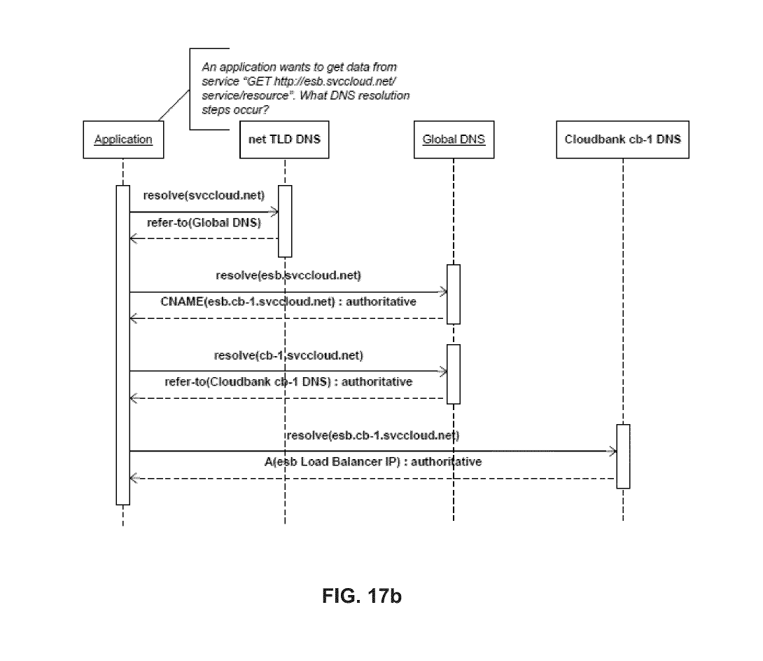

FIGS. 17a and 17b are sequence diagrams illustrating an example of DNS resolution of a global application (FIG. 17a) and a service call via ESB (FIG. 17b).

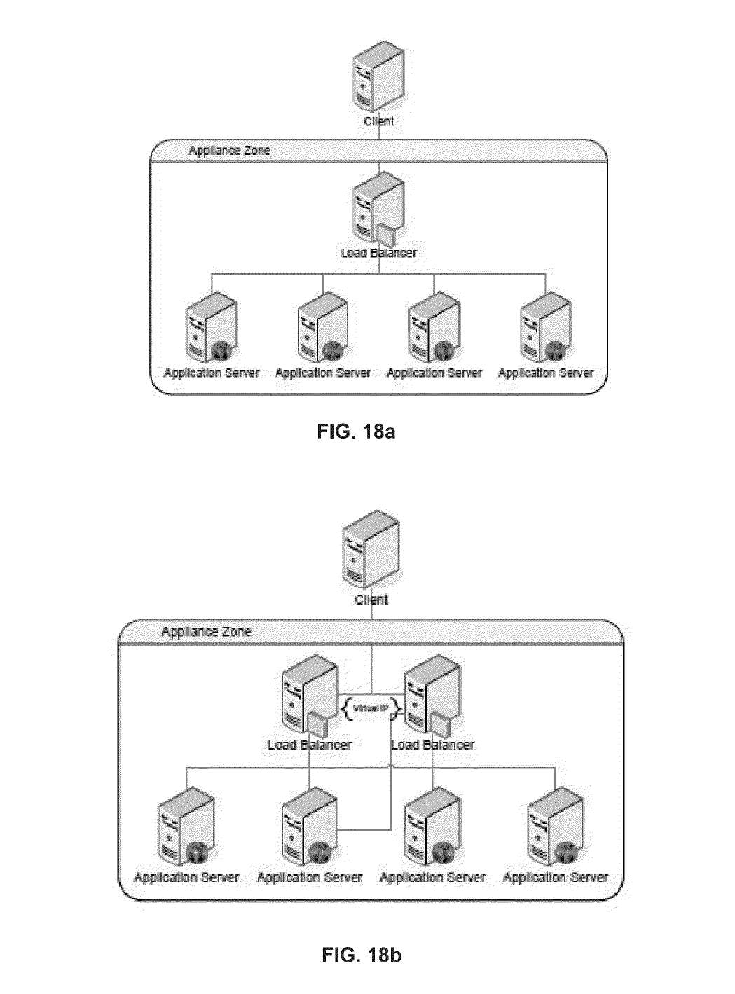

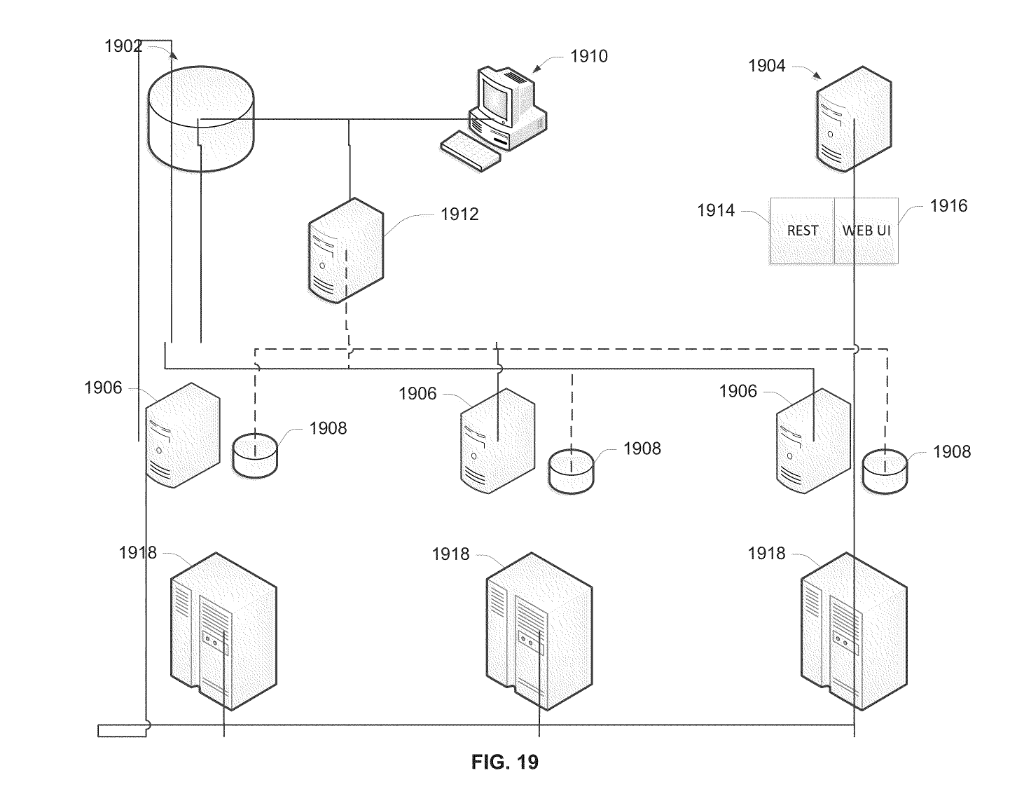

Load balancing may be provided at any level, particularly at the cloudbank and appliance zone levels. Appliance zone load balancers are virtual appliances that perform a load balancing function on behalf of other virtual appliances (typically web servers) running on the same zone subnet. The zone load-balancer is an optional component of the zone. The standard load-balancing model for an appliance zone is a single appliance configuration as shown in FIG. 18a. A multiple load-balancing model is shown in FIG. 18b.

### Fast Provisioning

In an embodiment of Infrastructure-as-a-Service, users of infrastructure units, such as web servers, databases, etc. may be allowed to rapidly deploy the required hardware and software without intervention from system administrators. This will greatly decrease the time it takes to put a unit into service, and greatly reduce the cost of doing so. In a preferred embodiment, a set of rules governs users' access to a fast provisioning system. Approved users may access the provisioning system with a user name and password.

### Provisioning System Technology Stack

Choosing a full technology stack on which to build a provisioning service is not an easy task. The effort may require several iterations using multiple programming languages and technologies. An exemplary technology stack is listed in Table 2 along with notes regarding features that make the technology a good choice for fast provisioning.

TABLE 2
Exemplary Fast Provisioning Technology Stack

| Type | Example Technology | Notes/Features |
|---|---|---|
| API | VSphere API | SOAP API with complex |
| | | bindings (Java and .NET); vijava |
| Language | Java | The natural choice for interacting |
| | | with viJava; |
| Language | Python | Interpreted language; large and |
| | | comprehensive standard library; |
| | | supports multiple programming |
| | | paradigms; features full dynamic |
| | | type system and automatic |
| | | memory management; java port |
| | | is “Jython” |
| Framework | Django | Development framework follows |
| | | model-template-view |
| | | architectural pattern and |
| | | emphasizes reusability and |
| | | “pluggability” of components, |
| | | rapid development, and the |
| | | principle of DRY (don't repeat |
| | | yourself) |
| | Piston - REST API | Piston |
| | Ajax | Dajax is a powerful tool to easily |
| | | and quickly develop |
| | | asynchronous presentation logic |
| | | in web applications using Python. |
| | | Supports the most popular JS |
| | | frameworks. Using dajaxice |
| | | communication core, dajax |
| | | implements an abstraction layer |
| | | between the presentation logic |
| | | managed with JS and the Python |
| | | business logic. DOM structure |
| | | modifiable directly from Python |
| | Javascript | Prototype Javascript framework |
| | | and scriptaculous |
| Database | MySQL | Popular, easy installation and |
| | | maintenance, free. |
| Web Server | Tomcat 5 | Jython runs on JVM |

FIG. 19 illustrates an exemplary component architectural diagram for an embodiment of a fast provisioning system. These components may be distributed across multiple data centers, possibly in disparate locations. A GIT repository supporting a fast provisioning system is typically broken out into two separate repositories. One 1902 contains all of the chef recipes, the other contains the code and scripts for the provisioning system itself 1904. The chef repository 1902 refers to a “book of truth” containing all the recipes used to build out and configure systems deployed using the fast provisioning system. Developers use this repository for code check in/checkout. It is a master repository used for merging changes into the branch master and uploading to chef servers 1906 and database 1908. The fast provisioning repository contains all the scripts written to support fast provisioning.

Each virtual data center (which may be comprised of a data center and a virtualization platform client) 1918 has its own chef server 1906. As part of the deploy process, clients (VMs) in each virtual data center 1918 register with the appropriate chef server. A chef server 1906 is further used to perform initial system configuration (package installation, file placement, configuration and repeatable administrative tasks) as well as for code updates and deployment. Access to the chef servers 1906 is typically controlled through a distributed name service and may be limited to engineers. A tool, such as VMWARE™ studio 1910 for example, may be used as the image creation mechanism. It is used for creating and maintaining versioned “gold master” Open Virtualization Format (OVF) images. Further customization of the guests is performed through a set of firstboot scripts, also contained within machine profiles in the studio.

A continuous integration server 1912 is used to distribute the OVF images to repositories in each virtual data center 1918. This server may also be used for a variety of other tasks, including building custom RPM Package Manager (RPM) packages, log management on the data powers and other event triggered tasks. Most importantly, it is used to automate the distribution of chef recipes on repository check-in.

The virtual data center 1918 localized package repositories 1908 contain copies of all of the OVF gold master images, as well as copies of all of the custom built RPM packages. These machines are standard guests with large NFS backed persistent storage back-ends to hold the data. Support for local repositories is installed through a chef script during initial configuration.

A RESTful domain name system (DNS) service 1914 may be used to handle all of the DNS registrations during the machine deployment process. Once a machine name and IP has been assigned by the fast provisioning service, an automated REST call is performed to do the registration.

The provisioning service communicates with each virtual data center server via a soap XML interface and communicates with Chef Servers via a REST interface 1914. The provisioning service provides a simple RESTful interface and Web UI for internal provisioning.

The Fast Provisioning System integrates the various underlying technologies and offers additional benefits, such as: Integration with DNS registration; integration with OPScode Chef for automated configuration of services; stores VM creation details for rapid deployment in the event of loss; provides finer privilege control; can decide exactly what a user sees and can do; integration with other disparate systems, like storage, monitoring and asset management; provides a simple REST interface for integration of the provisioning system into other tools and software; automatically uploads the appropriate OS image to the system during deployment with no extra steps.

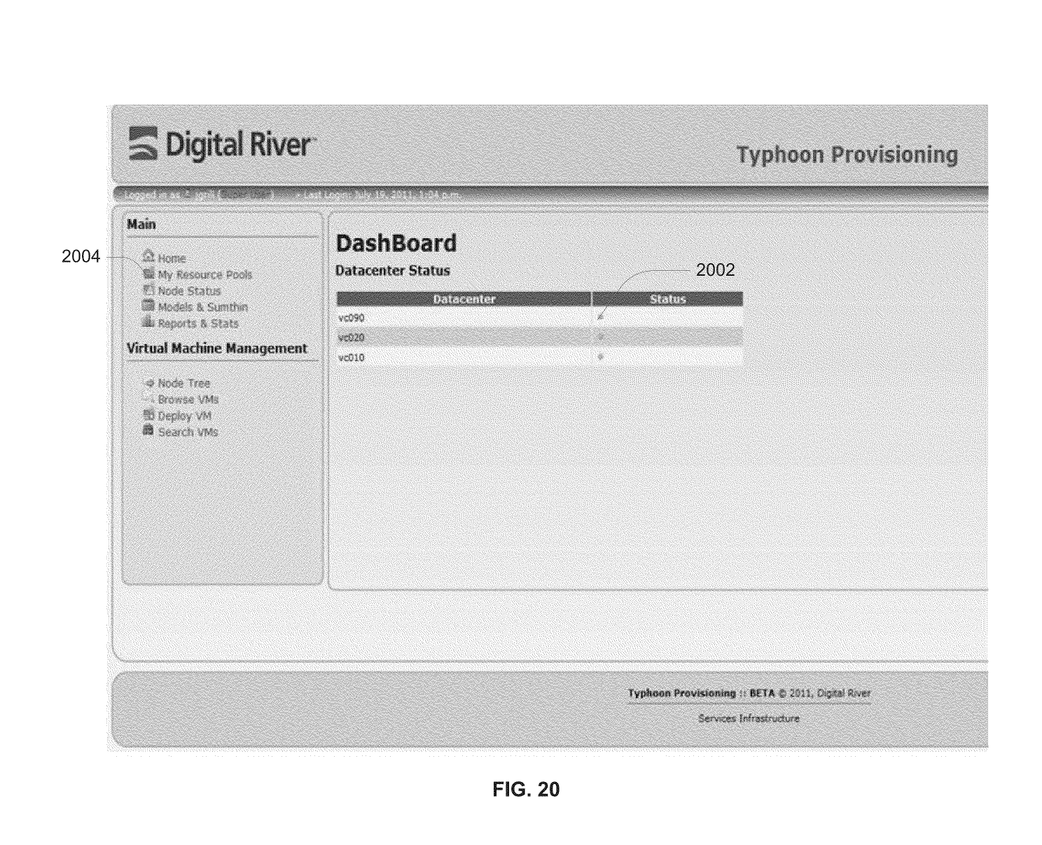

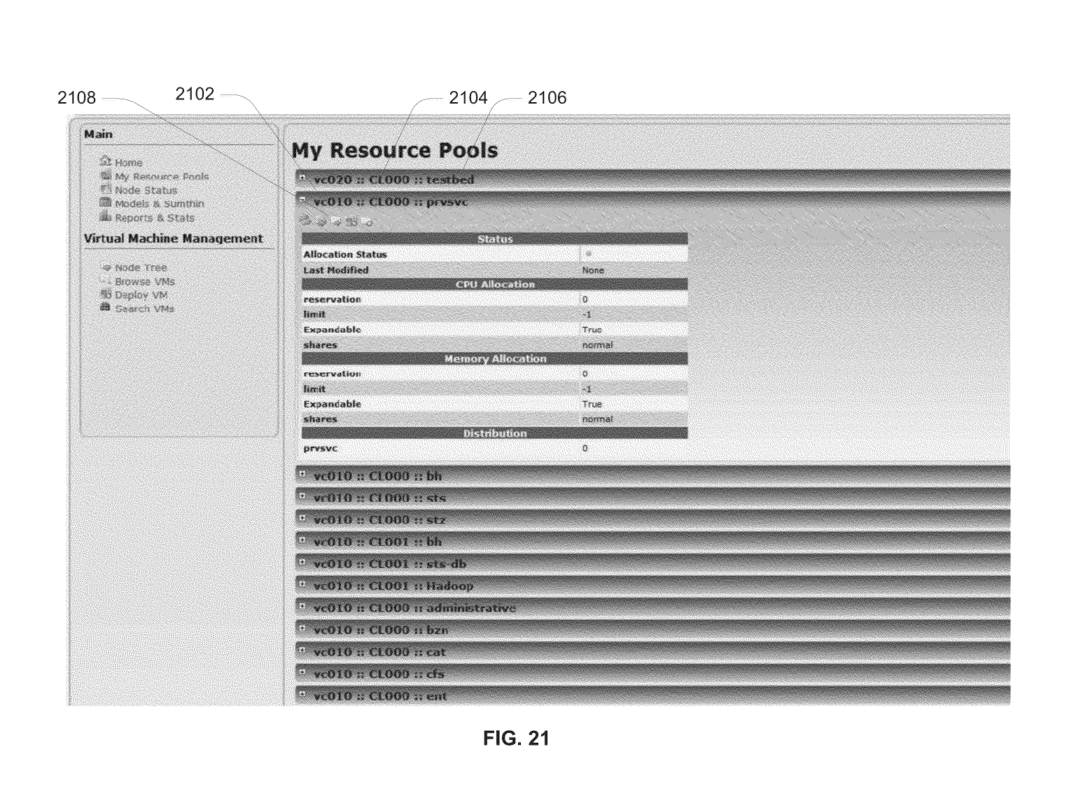

A preferred embodiment of a fast provisioning system and method includes a user interface and a number of modules, each module stored on computer-readable media and containing program code which when executed cause the system to perform the steps necessary to perform functions toward creating the virtual environment. The code modules may be integrated with various tools and systems for the creation and management of virtual resources. A graphical user interface (GUI) steps the user through the process of creating virtual resources. A preferred embodiment of a provisioning service is accessed with a user name and password provided to approved users. FIGS. 20-36 illustrate the provisioning process using a Fast Provisioning system and method. FIG. 20 illustrates a home screen that may include a dashboard showing datacenter status for all of the data centers for which the user has access. A status light 2002 may use an indicator color to convey the datacenter status to the user. Selecting “My Resource Pools” 2004 under the Main menu redirects the user to the My Resource Pools screen (FIG. 21), which allows the user to view status, CPU allocation, memory allocation and distribution details for each of the user's resources (i.e. server systems). The user presented with the resource pools in FIG. 21 has a number of resources 2106 in virtual centers vc020 and vc010 2102, on cloudlets CL000 and CL001 2104. Selecting the vc010::CL000::prvsvc resource provides the details for that resource. Icons below the resource name 2108 provide utilities that allow the user to refresh the cache to view changes in the display, view settings and resource pool details, and perform virtual machine management functions such as create and deploy new resources. An advantage of deploying a resource from this screen is that the resource will be deployed to the specific resource pool selected.

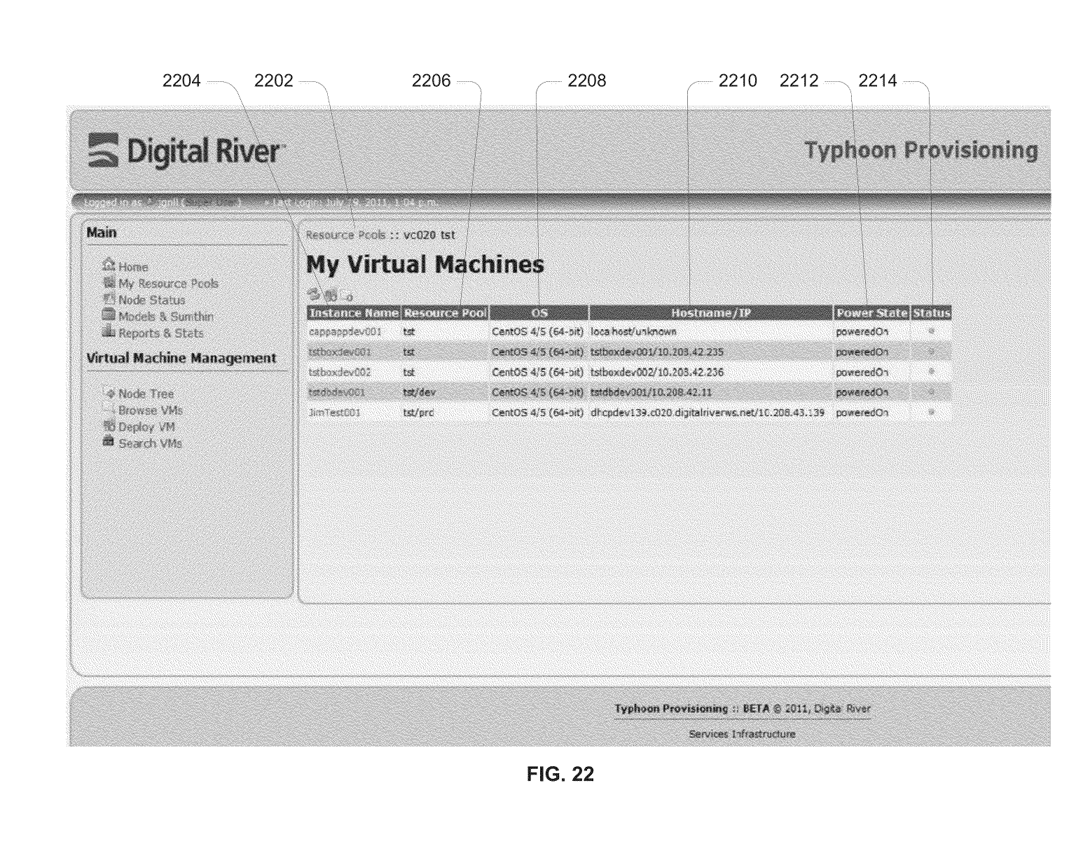

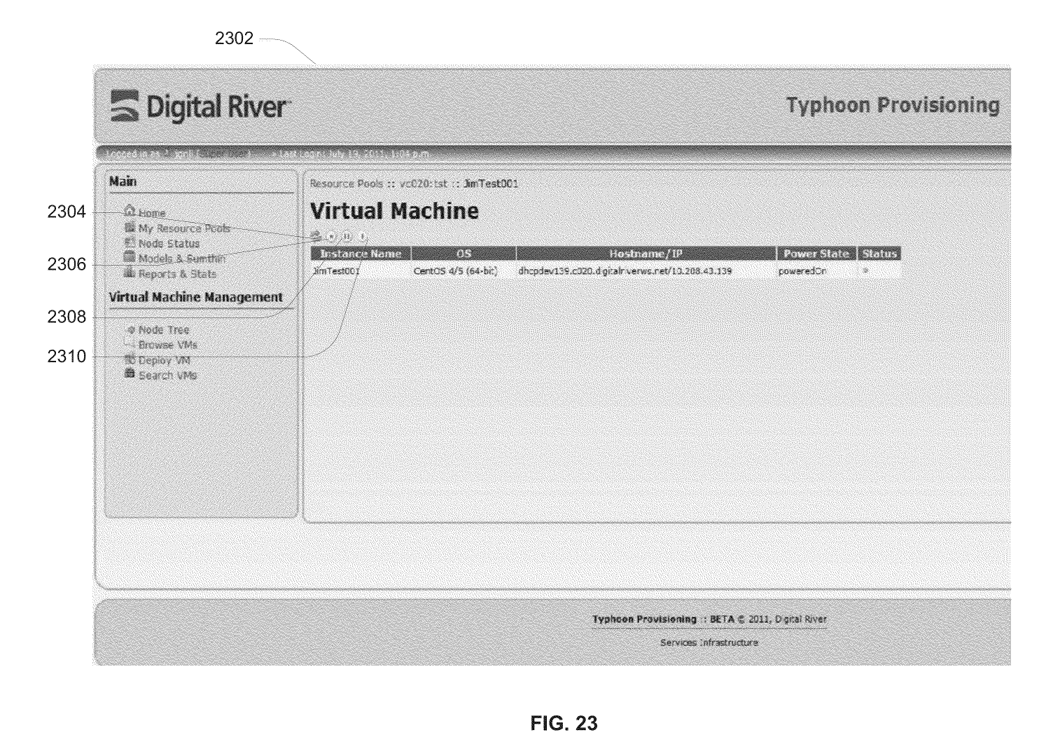

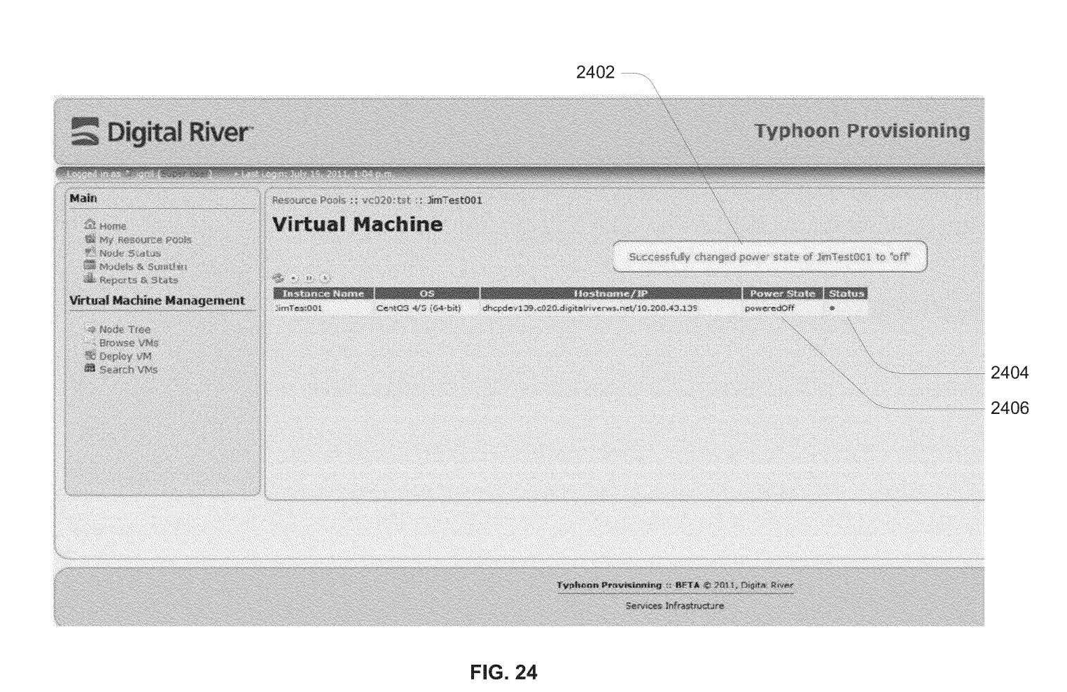

Referring now to FIG. 22, Drilling down on the resource pools 2202 in the virtual center allows the user to view all Virtual Machines assigned to the user, including the instance name 2204, resource pool 2206, operating system information 2208, hostname/IP address 2210, power state 2212 and status 2214. Selecting a particular virtual machine generates a screen specific to the selected virtual machine (FIG. 23 2302) and includes icons that allow the user to refresh the view 2304, power down 2306, suspend 2308, or power up 2310 the particular instance. When the user attempts to change the power state of the resource, the user is notified (FIG. 24) with a success or failure message 2402. The power state 2404 and status 2406 values change accordingly. The user may also view resources by selecting the node tree from the Virtual Machine Management menu on the left side of the screen (FIG. 24), and drill down to the virtual resource details from this screen.

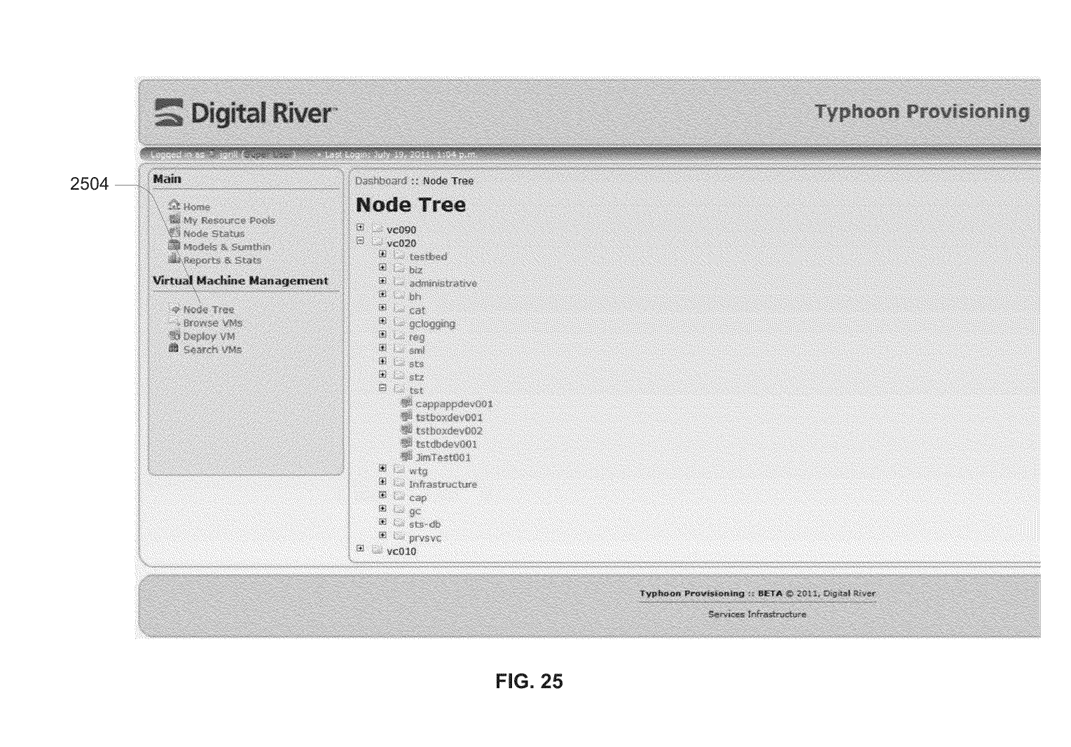

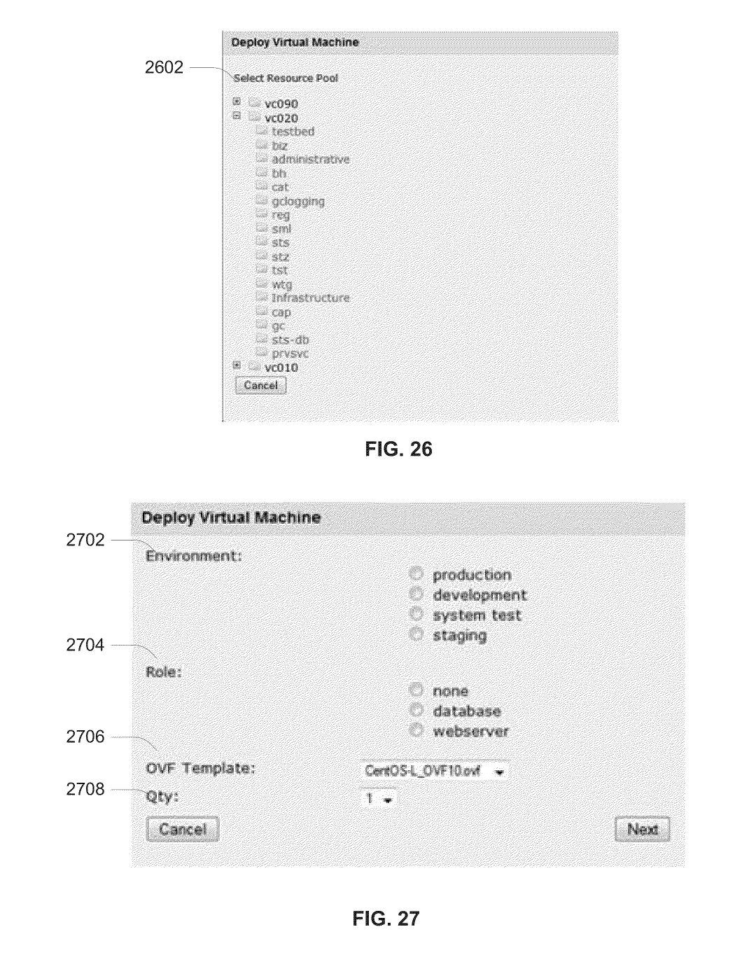

By selecting “Deploy VM” from the Virtual Machine Management menu, the user may deploy a resource into a particular pool. A “Deploy Virtual Machine” popup window (FIG. 25) allows the user to select the resource pool. This window may overlay the node tree view of FIG. 24. Selecting a pool may generate the “My Virtual Machines” screen (FIG. 26) from which the user may select a “deploy” icon 2602 to indicate from which resource pool to deploy. Various popup windows may offer options to the user.

Referring now to FIG. 27, the user is initially asked to select an environment and role for the new resource. A deployment life cycle may consist of a series of deployments for QA purposes, such as deploying to development, then test, then staging, and finally to production, depending on the requirements of the user. Any such life cycle may be accommodated by allowing the user to select the environment 2702 to which the resource will deploy. A machine role is also selected 2704. The role indicates the type of resource that is being deployed, such as database or web server. Roles allow the system to provide standard code files, or recipes, for configuring a particular type of server. The role selected will determine the options that are subsequently presented to the user. Choosing “no role” means the user must select from a variety of options for all components, rather than taking advantage of the prepackaged configurations. The user selects the OVF template for installation 2706, and the quantity of such resources required 2708.

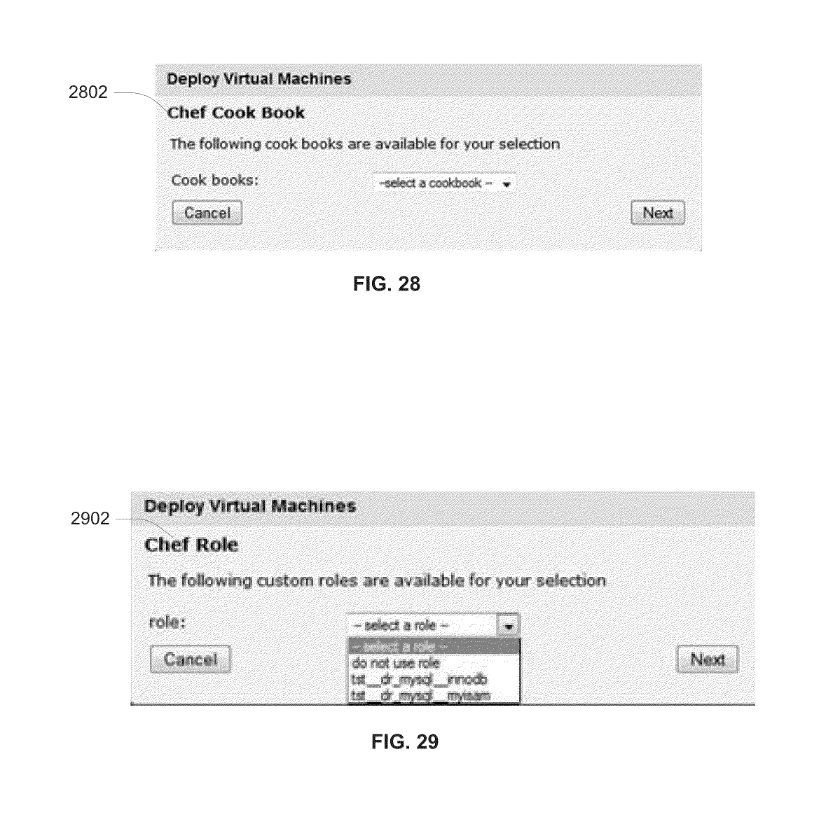

Next, the user selects a Chef Cook Book 2802 from the options available for the designated role (FIG. 28). The terms “chef,” “cook book” and “recipes” are used here to describe the roles, repositories and instructions, respectively, for creating the required resources. This terms are meant to be merely descriptive and not limiting in any way. As was discussed above, cook books hold “recipes” for creating the virtual machine. They consist of code modules that configure the system to company standards and requirements. The cook book may contain code for any type of desired feature. An exemplary cook book may be a “mysql” cook book which is offered as an option when a database role is selected along with others.

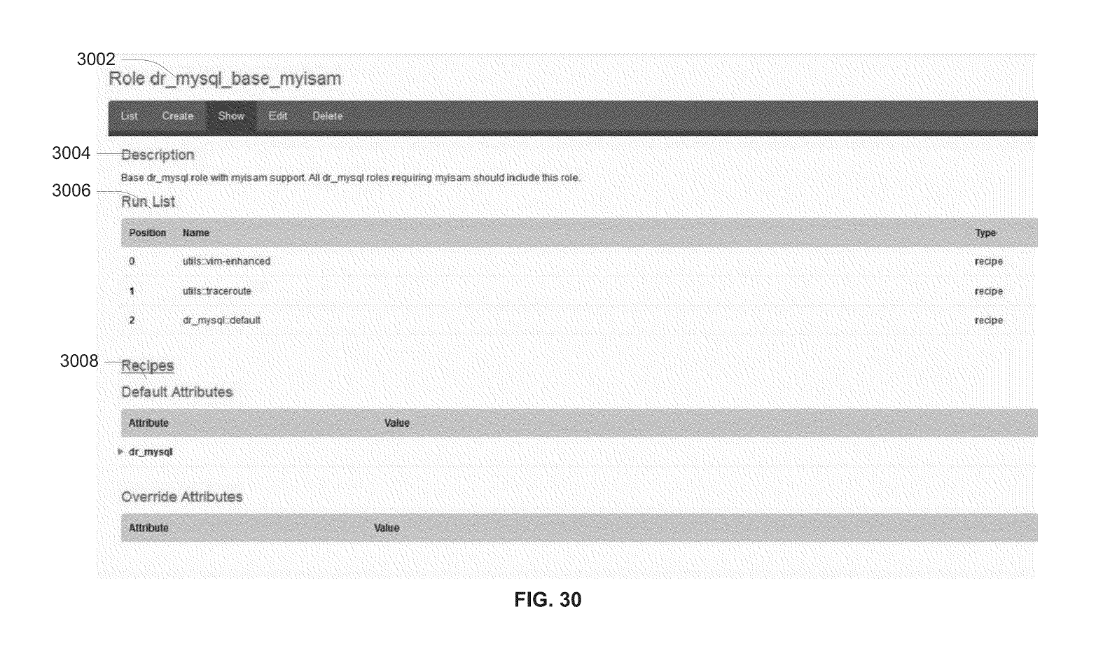

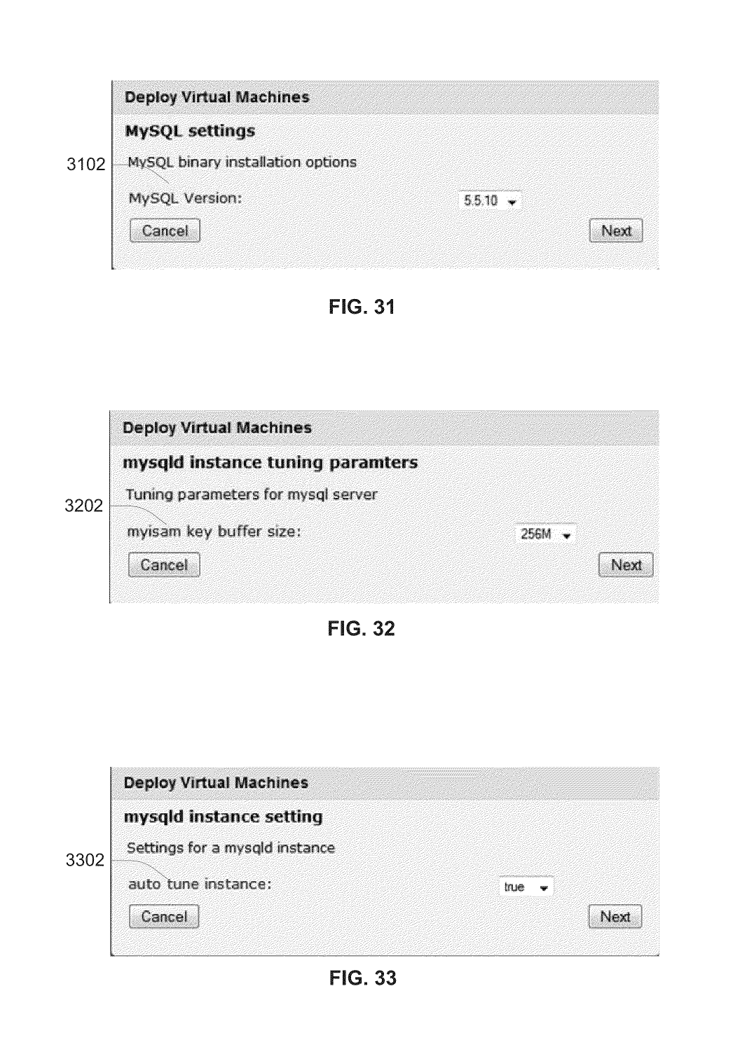

Next, as is illustrated in FIG. 29, the user chooses a Chef Role 2902 from those available for the selected resource. As with roles discussed above, each role further identifies the code and features that go into configuring a specific resource, and drive the options that are subsequently presented to the user. FIG. 30 is a screen shot of the recipes associated with an exemplary role. Such a screen in a preferred embodiment of a role 3002 provides a description of the recipes 3004 included in the role along with a run list 3006, and default or other required attributes 3008. In FIGS. 31, 32 and 33, the user is presented with options for settings used to deploy virtual machines, such as which of the company's supported version of the software 3102 is desired (FIG. 31), application tuning requirements 3202 (FIG. 32) and, if so, options for tuning parameters 3302 (FIG. 33).

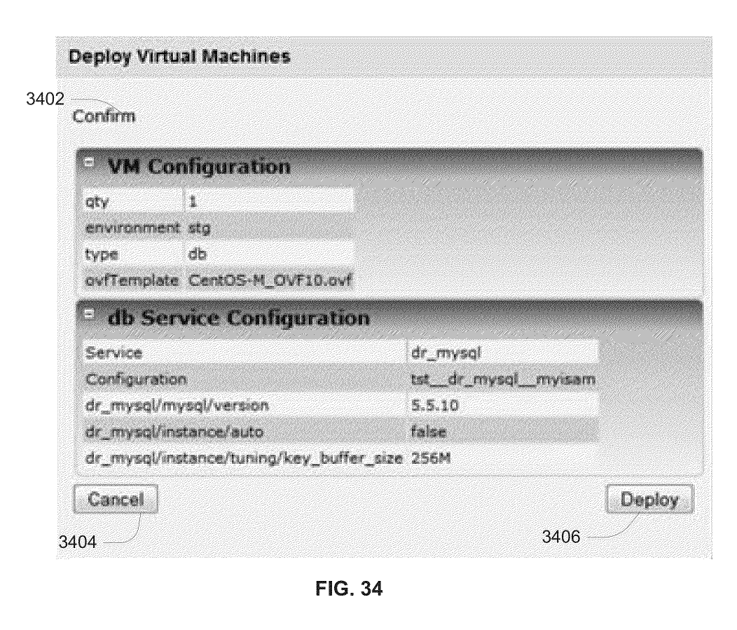

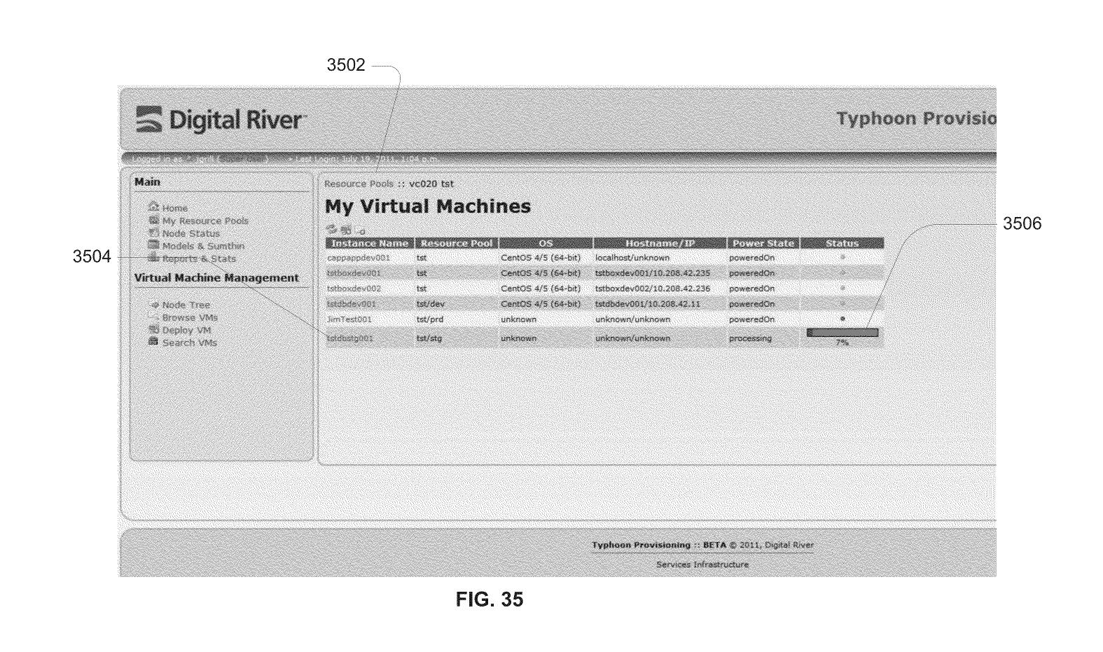

When all of the options and features for a resource role have been selected, the user may be presented with a confirmation popup window 3402, as shown in FIG. 34. All of the selected parameters and values are presented to the user so that they may be confirmed before deploying the instance. The user may cancel the configuration 3404 or deploy the virtual machine as configured 3406. When the user clicks the “Deploy” button 3406, a screen may be displayed 3502 showing all of the virtual machines associated with the user (FIG. 35). The deploying instance 3504 is included on the list of resources, along with a processing status bar 3506. A status message is presented to the user when deployment has completed or has been aborted for some reason.

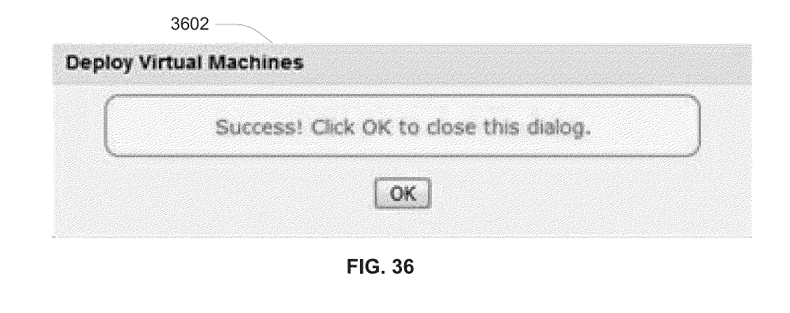

Back-end processing includes assigning an IP address and host name, and registering these identifiers with the DNS; creating the virtual space for the server and installing the requested software. The user is presented with a confirmation that the resource creation process is completed and fully deployed (FIG. 36).

The individual components of the disclosed system and method are necessarily composed of a number of electronic components. Ecommerce systems are hosted on servers that are accessed by networked (e.g. internet) users through a web browser on a remote computing device. One of ordinary skill in the art will recognize that a “host” is a computer system that is accessed by a user, usually over cable or phone lines, while the user is working at a remote location. The system that contains the data is the host, while the computer at which the user sits is the remote computer. Software modules may be referred to as being “hosted” by a server. In other words, the modules are stored in memory for execution by a processor. The ecommerce application generally comprises application programming interfaces, a commerce engine, services, third party services and solutions and merchant and partner integrations. The application programming interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, end users may access the ecommerce system from a computer workstation or server, a desktop or laptop computer, a mobile device, or other electronic telecommunications or computing device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Merchant integrations may be comprised of merchant external systems (customer relationship management, financials, etc), sales feeds and reports and catalog and product feeds. Partner integrations may include fulfillment partners, merchant fulfillment systems, and warehouse and logistics providers. Any or all of these components may be used to support the various features of the disclosed system and method.

An electronic computing or telecommunications device, such as a laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Software applications, stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired. Where performance is impacted, additional processing power may be provisioned quickly to support computing needs.

A secondary storage device may include a hard disk drive, floppy disk drive, CD-ROM drive, DVD-ROM drive, or other types of non-volatile data storage, and may correspond with the various equipment and modules shown in the figures. The secondary device could also be in the cloud. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a PC computer monitor, a laptop screen, a phone screen interface or flat-screen display. The output device may include any type of device for presenting a hard copy of information, such as a printer, and other types of output devices include speakers or any device for providing information in audio form.

Although the computer, computing device or server has been described with various components, it should be noted that such a computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be merchant or server computers. Merchant computers and devices (e.g.) are those used by end users to access information from a server over a network, such as the Internet. These devices can be a desktop PC or laptop computer, a standalone desktop, smart phone, smart TV, or any other type of computing device. Servers are understood to be those computing devices that provide services to other machines, and can be (but are not required to be) dedicated to hosting applications or content to be accessed by any number of merchant computers. Web servers, application servers and data storage servers may be hosted on the same or different machines. They may be located together or be distributed across locations. Operations may be performed from a single computing device or distributed across geographically or logically diverse locations.

Client computers, computing devices and telecommunications devices access features of the system described herein using Web Services and APIs. Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically web service definition language or WSDL). Other systems interact with the web service in a manner prescribed by its description using Simple Object Access Protocol (SOAP) messages, typically conveyed using hypertext transfer protocol (HTTP) or hypertext transfer protocol secure (HTTPS) with an Extensible Markup Language (XML) serialization in conjunction with other web-related standards.” Web services are similar to components that can be integrated into more complex distributed applications.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular physical components, software development tools and code and infrastructure management software may vary depending on the particular system design, while maintaining substantially the same features and functionality and without departing from the scope and spirit of the present invention.

What is claimed is:

1. An automated platform-as-a-service provisioning system, comprising:
a system deployment module operatively configured to receive specifications for and direct the creation of a computing platform;
an operations orchestration module operatively configured to guide the workflow of component modules and sub-systems to carry out provisioning of a platform;
an automation center module operatively configured to create and tune virtual machine components of a platform based on received specifications;
an automation platform operatively configured to install software and configuration details on the created machine based on instructions stored in memory;
a repository module containing all artifacts related to a platform and accessible by the automation platform.

2. The automated platform-as-a-service provisioning system of claim 1 where the system further comprises a configurations and applications management module; and
a build tool operatively configured to transform configuration details and applications into files that are accessible to and readable by the automation platform.

3. A method for fast provisioning of a platform-as-a-service, comprising:
receiving a specification for a platform;
creating an infrastructure template of the platform based on the requested platform specification;
creating a platform model by installing applications and configuration details;
replicating the platform model to meet capacity and location requirements;
registering the location with the data center and network details required to identify the platform.
